(19) United States
(12) Patent Application Publication
(10) Pub. No.: US 2021/0083323 A1
(43) Pub. Date: Mar. 18, 2021

(54) SOLID ELECTROLYTE COMPOSITION, SOLID ELECTROLYTE-CONTAINING SHEET, ALL-SOLID STATE SECONDARY BATTERY, METHOD OF MANUFACTURING SOLID ELECTROLYTE-CONTAINING SHEET, AND METHOD OF MANUFACTURING ALL-SOLID STATE SECONDARY BATTERY

(71) Applicant: FUJIFILM Corporation, Tokyo (JP)

(72) Inventor: Tomonori MIMURA, Kanagawa (JP)

(73) Assignee: FUJIFILM Corporation, Tokyo (JP)

(21) Appl. No.: 17/100,947

(22) Filed: Nov. 23, 2020

Related U.S. Application Data
(63) Continuation of application No. PCT/JP2019/028368, filed on Jul. 18, 2019.

(30) Foreign Application Priority Data
Jul. 27, 2018 (JP) 2018-141431

(51) Int. Cl. H01M 10/0562; C08F 20/12; C08K 3/40

(52) U.S. Cl. CPC H01M 10/0562; H01M 2300/0068; C08K 3/40; C08F 20/12

(57) ABSTRACT

Provided is a solid electrolyte composition including: an inorganic solid electrolyte having ion conductivity of a metal belonging to Group 1 or Group 2 in the periodic table; a binder including a polymer that includes a specific structural unit having 6 or more carbon atoms; and a dispersion medium. Provided are a solid electrolyte-containing sheet and an all-solid state secondary battery that include a layer formed of the composition, and method of manufacturing a solid electrolyte-containing sheet and an all-solid state secondary battery.

### CROSS-REFERENCE TO RELATED APPLICATIONS

This application is a Continuation of PCT International Application No. PCT/JP2019/028368 filed on Jul. 18, 2019, which claims priority under 35 U.S.C. § 119 (a) to Japanese Patent Application No. 2018-141431 filed in Japan on Jul. 27, 2018. Each of the above applications is hereby expressly incorporated by reference, in its entirety, into the present application.

### BACKGROUND OF THE INVENTION

### 1. Field of the Invention

The present invention relates to a solid electrolyte composition, a solid electrolyte-containing sheet, an all-solid state secondary battery, a method of manufacturing a solid electrolyte-containing sheet, and a method of manufacturing an all-solid state secondary battery.

### 2. Description of the Related Art

A lithium ion secondary battery is a storage battery including a negative electrode, a positive electrode, and an electrolyte sandwiched between the negative electrode and the positive electrode and enables charging and discharging by the reciprocal migration of lithium ions between both electrodes. In the related art, in lithium ion secondary batteries, an organic electrolytic solution has been used as the electrolyte. However, in organic electrolytic solutions, liquid leakage is likely to occur, there is a concern that a short-circuit and ignition may be caused in batteries due to overcharging or overdischarging, and there is a demand for additional improvement in safety and reliability.

Under these circumstances, all-solid state secondary batteries in which an inorganic solid electrolyte is used instead of the organic electrolytic solution are attracting attention. In an all-solid state secondary battery, a negative electrode, an electrolyte, and a positive electrode are all solid, and safety or reliability batteries including an organic electrolytic solution can be significantly improved.

In the all-solid state secondary battery, as a material for forming a layer (constituent layer) forming an all-solid state secondary battery such as a negative electrode active material layer, a solid electrolyte layer, or a positive electrode active material layer, a material including an inorganic solid electrolyte, an active material, and a binder is disclosed.

For example, WO2016/129427A describes a solid electrolyte composition including: an inorganic solid electrolyte; binder particles formed of a polymer having a reactive group; a dispersion medium; and at least one component selected from a crosslinking agent or a crosslinking accelerator. During use of the solid electrolyte composition, the binder particles attached to particles of the inorganic solid electrolyte or an active material are cured by a crosslinking agent or a crosslinking accelerator. In addition, WO2012/173089A describes a slurry including: an inorganic solid electrolyte; and a binder formed of a particle polymer having an average particle size 30 to 300 nm. JP2017-130264A describes a solid electrolyte composition including an inorganic solid electrolyte and a binder that includes a branched polymer having three or more polymer polymerization initiator residues at a terminal of a polymer molecule.

### SUMMARY OF THE INVENTION

Typically, a constituent layer of an all-solid state secondary battery is formed of solid particles such as an inorganic solid electrolyte, binder particles, or an active material. Therefore, there is a restriction on interfacial contact between the solid particles and interfacial contact between the solid particles and a current collector or the like, and the interface resistance increases (there is a restriction on improvement of ion conductivity). On the other hand, due to the restriction on interfacial contact, a constituent layer formed on the surface of the current collector is likely to peel off. In addition, poor contact between the solid particles is likely to occur due to contraction and expansion of a constituent layer, in particular, an active material layer caused by charging and discharging of an all-solid state secondary battery (intercalation and deintercalation of lithium ions), which may cause an increase in electrical resistance and further a decrease in battery performance.

An object of the present invention is to provide a solid electrolyte composition. By using this solid electrolyte composition as a material for forming a constituent layer of an all-solid state secondary battery, while suppressing an increase in interface resistance between solid particles, solid particles can be strongly bound to each other, and excellent battery performance can be realized. In addition, another object of the present invention is to provide a solid electrolyte-containing sheet, an electrode sheet for an all-solid state secondary battery, and an all-solid state secondary battery that include a layer formed of the solid electrolyte composition. Still another object of the present invention is to provide methods of manufacturing a solid electrolyte-containing sheet and an all-solid state secondary battery in which the solid electrolyte composition is used.

The present inventors repeatedly conducted a thorough investigation and found that, by using a binder including a specific polymer that includes a structural unit having 6 or more carbon atoms represented by Formula (H-1) or (H-2) described below in combination with an inorganic solid electrolyte and a dispersion medium, the obtained solid electrolyte composition exhibits excellent dispersibility. Further, it was also found that, by using this solid electrolyte composition as a material for forming a constituent layer of an all-solid state secondary battery, a constituent layer in which solid particles are strongly bonded to each other while suppressing interface resistance between the solid particles can be formed, and excellent battery performance can be imparted to the all-solid state secondary battery. The present invention has been completed based on the above findings as a result of repeated investigation.

That is, the above-described objects have been achieved by the following means.

<1> A solid electrolyte composition comprising:

(A) an inorganic solid electrolyte having ion conductivity of a metal belonging to Group 1 or Group 2 in the periodic table;

(B) a binder including a polymer that includes a structural unit having 6 or more carbon atoms represented by Formula (H-1) or (H-2); and

(C) a dispersion medium,

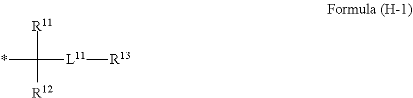

in the formula, R¹¹ and R¹² represents a cyano group, an alkyl group, an alkyloxycarbonyl group, an alkylcarbonyloxy group, a 2-imidazolin-1-yl group, or an aryl group,

R¹³ represents a hydrogen atom, an alkyl group, a hydroxy group, a carboxy group, a 2-imidazolin-1-yl group, or an aryl group,

L¹¹ represents a single bond, an alkylene group having 1 to 6 carbon atoms, an alkenylene group having 2 to 6 carbon atoms, an arylene group having 6 to 24 carbon atoms, an oxygen atom, a sulfur atom, —N(R^{N})—, a carbonyl group, a silane linking group, an imine linking group, a phosphate linking group, a phosphonate linking group, or a group including a combination of two or more among the above-described groups, atoms, and linking groups,

R^{N} represents a hydrogen atom or an alkyl group having 1 to 12 carbon atoms, and

* represents a binding site to a polymer main body,

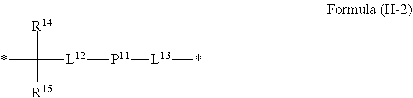

in the formula, R¹⁴ and R¹⁵ represents a cyano group, an alkyl group, an alkyloxycarbonyl group, an alkylcarbonyloxy group, a 2-imidazolin-1-yl group, or an aryl group,

L¹² and L¹³ each independently represent a single bond, an alkylene group having 1 to 6 carbon atoms, an alkenylene group having 2 to 6 carbon atoms, an arylene group having 6 to 24 carbon atoms, an oxygen atom, a sulfur atom, —N(R^{N})—, a carbonyl group, a silane linking group, an imine linking group, a phosphate linking group, a phosphonate linking group, or a group including a combination of two or more among the above-described groups, atoms, and linking groups,

P¹¹ represents a polyalkyleneoxy group or a polyalkoxysilylene group,

R^{N} represents a hydrogen atom or an alkyl group having 1 to 12 carbon atoms, and * represents a binding site to a polymer main body.

<2> The solid electrolyte composition according to <1>,

in which the polymer in the binder (B) is formed of particles having an average particle size of 5 nm to 10 μm.

<3> The solid electrolyte composition according to <1> or <2>,

in which the structural unit represented by Formula (H-1) is a structural unit represented by Formula (H-3), and the structural unit represented by Formula (H-2) is a structural unit represented by Formula (H-4),

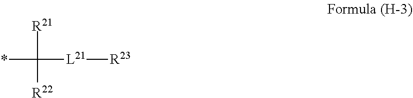

in the formula, R²¹ represents a methyl group, a cyano group, an alkyloxycarbonyl group, an alkylcarbonyloxy group, or a 2-imidazolin-1-yl group,

R²² represents an alkyl group having 1 to 6 carbon atoms, a cyano group, an alkyloxycarbonyl group, or an alkylcarbonyloxy group,

R²³ represents a cycloalkyl group, a methoxy group, a hydroxy group, a carboxy group, a 2-imidazolin-1-yl group, or an aryl group,

in a case where R²³ represents a cycloalkyl group, R²³ may linked to R²¹,

L²¹ represents a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups,

R^{N} represents a hydrogen atom or an alkyl group having 1 to 12 carbon atoms,

“L²¹-R²³” does not represent “an alkylene group having 1 to 6 carbon atoms—an aryl group”, and

* represents a binding site to a polymer main body,

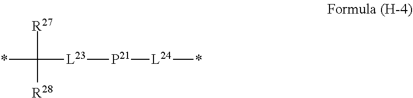

in the formula, R²⁷ and R²⁸ each independently represent a cyano group, an alkyl group having 1 to 6 carbon atoms, an alkyloxycarbonyl group, or an alkylcarbonyloxy group,

L²³ and L²⁴ each independently represent a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups,

R^{N} represents a hydrogen atom or an alkyl group having 1 to 12 carbon atoms,

P²¹ represents a polyalkyleneoxy group or a polyalkoxysilylene group, and

* represents a binding site to a polymer main body.

<4> The solid electrolyte composition according to anyone of <1> to <3>,

in which the structural unit represented by Formula (H-2) is a structural unit represented by Formula (H-5),

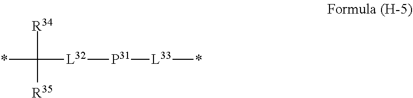

in the formula, R³⁴ and R³⁵ each independently represent a cyano group, an alkyl group having 1 to 6 carbon atoms, an alkyloxycarbonyl group, or an alkylcarbonyloxy group,

L³² and L³³ each independently represent a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups,

P³¹ represents a polyalkyleneoxy group or a polyalkoxysilylene group having a mass average molecular weight of 1000 or higher,

R^{N} represents a hydrogen atom or an alkyl group having 1 to 12 carbon atoms, and

* represents a binding site to a polymer main body.

<5> The solid electrolyte composition according to anyone of <1> to <4>,

in which the polymer in the binder (B) does not include a component having 2 or more polymerizable sites.

<6> The solid electrolyte composition according to anyone of <1> to <5>,

in which the polymer in the binder (B) includes a repeating unit (K) represented by Formula (R-1),

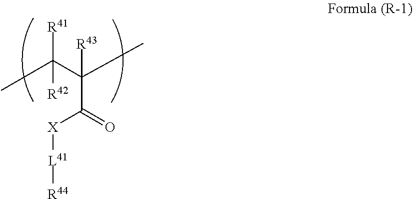

in the formula, R⁴¹ to R⁴³ each independently represent a hydrogen atom, a cyano group, a halogen atom, or an alkyl group,

X represents an oxygen atom or NR^{N},

R^{N} represents a hydrogen atom or an alkyl group having 1 to 12 carbon atoms,

L⁴ represents a linking group, and

R⁴⁴ represents a substituent.

<7> The solid electrolyte composition according to anyone of <1> to <6>,

in which a content of the structural unit having 6 or more carbon atoms represented by Formula (H-1) or (H-2) is 2 mass % or higher with respect to a mass of the polymer in the binder (B).

<8> The solid electrolyte composition according to any one of <1> to <7>,

in which the polymer in the binder (B) includes at least one selected from Group (a) of functional groups,

Group (a) of functional groups

a carboxy group, a sulfonate group, a phosphate group, a phosphonate group, an isocyanate group, and a silyl group.

<9> The solid electrolyte composition according to <6>,

in which the repeating unit (K) includes at least one selected from Group (a) of functional groups, and

a content of the repeating unit (K) is 15 mass % or higher with respect to all components of the polymer in the binder (B),

Group (a) of functional groups

a carboxy group, a sulfonate group, a phosphate group, a phosphonate group, an isocyanate group, and a silyl group.

<10> The solid electrolyte composition according to anyone of <1> to <9>,

in which the inorganic solid electrolyte (A) is a sulfide-based inorganic solid electrolyte.

<11> The solid electrolyte composition according to anyone of <1> to <10>,

in which the dispersion medium (C) includes at least one selected from a ketone compound solvent, an ester compound solvent, an aromatic compound solvent, or an aliphatic compound solvent.

<12> The solid electrolyte composition according to any one of <1> to <11>, comprising:

(D) an active material capable of intercalating and deintercalating ions of a metal belonging to Group 1 or Group 2 in the periodic table.

<13> A solid electrolyte-containing sheet comprising:

a layer formed of the solid electrolyte composition according to any one of <1> to <12>.

<14> An all-solid state secondary battery comprising a positive electrode active material layer, a solid electrolyte layer, and a negative electrode active material layer in this order,

in which at least one of the positive electrode active material layer, the solid electrolyte layer, or the negative electrode active material layer is formed of the solid electrolyte composition according to any one of <1> to <12>.

<15> A method of manufacturing a solid electrolyte-containing sheet, the method comprising:

forming a film using the solid electrolyte composition according to any one of <1> to <12>.

<16> A method of manufacturing an all-solid state secondary battery, the method comprising:

manufacturing an all-solid state secondary battery using the method according to <15>.

The present invention can provide a solid electrolyte composition having excellent dispersibility. In an all-solid state secondary battery that is obtained by using this solid electrolyte composition as a material for forming a layer forming a constituent layer of an all-solid state secondary battery, while suppressing an increase in interface resistance between solid particles, solid particles can be strongly bound to each other, and excellent battery performance can be realized. The present invention can also provide a solid electrolyte-containing sheet, an electrode sheet for an all-solid state secondary battery, and an all-solid state secondary battery that include a layer formed of the solid electrolyte composition. Further, the present invention can also provide methods of manufacturing a solid electrolyte-containing sheet and an all-solid state secondary battery in which the solid electrolyte composition is used. In addition, the present invention can also provide a suitable method of manufacturing a particle binder used in the solid electrolyte composition.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating an all-solid state secondary battery (coin battery) prepared in Examples.

### DESCRIPTION OF THE PREFERRED EMBODIMENTS

In the description of the present invention, numerical ranges represented by “to” include numerical values before and after “to” as lower limit values and upper limit values.

In the description of the present specification, the simple expression “acryl” or “(meth)acryl” refers to acryl and/or methacryl.

In the present specification, the expression of a compound (for example, in a case where a compound is represented by an expression with “compound” added to the end) refers to not only the compound itself but also a salt or an ion thereof. In addition, this expression also refers to a derivative obtained by modifying a part of the compound, for example, by introducing a substituent into the compound within a range where desired effects are exhibited.

A substituent, a linking group, or the like (hereinafter, referred to as “substituent or the like”) is not specified in the present specification regarding whether to be substituted or unsubstituted may have an appropriate substituent. Accordingly, even in a case where a YYY group is simply described in the present specification, this YYY group includes not only an aspect having a substituent but also an aspect not having a substituent. The same shall be applied to a compound which is not specified in the present specification regarding whether to be substituted or unsubstituted. Preferable examples of the substituent include a substituent T described below.

In the present specification, in a case where a plurality of substituents or the like represented by a specific reference numeral are present or a plurality of substituents or the like are simultaneously or alternatively defined, the respective substituents or the like may be the same as or different from each other. In addition, unless specified otherwise, in a case where a plurality of substituents or the like are adjacent to each other, the substituents may be linked or fused to each other to form a ring.

In the present specification, unless specified otherwise, the form of a polymer is not particularly limited and may be any form such as a random polymer, a block polymer, or a graft polymer within a range where the effects of the present invention do not deteriorate.

In the present specification, a terminal structure of a polymer is not particularly limited and is appropriately determined depending on the kind of compounds used for the synthesis, the kind of a quenching agent (reaction terminator) used for the synthesis, and the like without being uniquely determined. Examples of the terminal structure include a hydrogen atom, a hydroxy group, a halogen atom, an ethylenically unsaturated group, and an alkyl group.

[Solid Electrolyte Composition]

A solid electrolyte composition according to an embodiment of the present invention (also referred to as “inorganic solid electrolyte-containing composition” comprising: (A) an inorganic solid electrolyte having ion conductivity of a metal belonging to Group 1 or Group 2 in the periodic table (hereinafter, also referred to as “the inorganic solid electrolyte (A)” or “the inorganic solid electrolyte”); (B) a binder including a polymer (polymer described below) that includes a structural unit having 6 or more carbon atoms represented by Formula (H-1) or (H-2) (hereinafter also referred to as “the binder (B)” or “the binder”); and (C) a dispersion medium (hereinafter also referred to as “the dispersion medium”).

The solid electrolyte composition may be in a dispersed state (suspension) in which the inorganic solid electrolyte (A) and the binder (B) in a solid state are dispersed in the dispersion medium (C) or may be a solution in which the binder (B) is dissolved in the dispersion medium (C). The solid electrolyte composition is preferably in a dispersed state and more preferably a slurry. The binder (B) is not particularly limited as long as, in a case where the binder (B) is used for a constituent layer of all-solid state secondary battery or an applied and dried layer of the solid electrolyte composition described below, the binder particles can bind solid particles of the inorganic solid electrolyte and the like to each other and further bind solid particles and an adjacent layer (for example, a current collector) to each other. The particle binder does not have to bind the solid particles in the dispersed state of the solid electrolyte composition.

In the solid electrolyte composition according to the embodiment of the present invention, in a case where the inorganic solid electrolyte (A) and the binder (B) are present together in the dispersion medium (C), the inorganic solid electrolyte (A) can be highly and stably dispersed, and the dispersibility of the solid electrolyte composition can be improved. In a case where a constituent layer of an all-solid state secondary battery is formed using the solid electrolyte composition, solid particles and further solid particles and a current collector or the like can be strongly bound to each other. The details of the reason for this are not clear but considered to be as follows.

The binder in the solid electrolyte composition according to the embodiment of the present invention is formed to include a polymer that includes a structural unit having 6 or more carbon atoms represented by Formula (H-1) or (H-2). That is, this polymer includes, in the dispersion medium, a structural unit having high affinity to solid particles such as the inorganic solid electrolyte (for example, a specific structural unit represented by Formula (H-1) or (H-2)) and other structural units (for example, an alkylene chain as a polymer main chain). As a result, the solid particle dispersibility and the dispersion stability can be highly improved. Further, a constituent layer of an all-solid state secondary battery can be formed while maintaining affinity to the solid particles. Therefore, in the obtained constituent layer, the solid particles can be strongly bound to each other. In addition, in a case where a constituent layer is formed on a current collector, the current collector and the solid particles can be strongly bound to each other.

On the other hand, due to the action of the portion of the binder (B) other than the specific structural unit represented by Formula (H-1) or (H-2), during drying for layer formation, the above-described solid particles can be suppressed from being covered with the binder, and an ion conduction path can be secured. Therefore, even in a case where the affinity to the solid particles is high, the interface resistance between the solid particles can be suppressed to be low.

This way, the high and stable dispersibility of the solid electrolyte composition and the strong binding properties between the solid particles and the like can be simultaneously realized (maintained) on a high level while suppressing an increase in interface resistance. Accordingly, in the constituent layer formed of the solid electrolyte composition according to the embodiment of the present invention, the contact state between the solid particles (the amount of an ion conduction path constructed), and the binding strength between the solid particles are improved with a good balance. As a result, it is considered that, even while constructing an ion conduction path, the solid particles and the like are bound to each other with strong binding properties, and the interface resistance between the solid particles is low. In each of sheets or an all-solid state secondary battery including the constituent layer having the excellent characteristics, high ion conductivity is exhibited while suppressing an increase in electrical resistance. Further, the excellent battery performance can be maintained even in a case where charging and discharging is repeated.

In the present invention, the dispersibility of the solid electrolyte composition being excellent represents, for example, a state where the dispersibility is evaluated as an evaluation standard of “5” or higher in “Dispersibility Test” in Examples described below.

The solid electrolyte composition according to the embodiment of the present invention includes an aspect including not only an inorganic solid electrolyte but also an active material and optionally an conductive auxiliary agent or the like as dispersoids (the composition in this aspect will be referred to as “electrode layer-forming composition”).

The solid electrolyte composition according to the embodiment of the present invention is a non-aqueous composition. In the present invention, the non-aqueous composition includes not only an aspect not including moisture but also an aspect where the moisture content (also referred to as “water content”) is 50 ppm or lower. In the non-aqueous composition, the moisture content is preferably 20 ppm or lower, more preferably 10 ppm or lower, and still more preferably 5 ppm or lower. The moisture content refers to the content of water (mass ratio to the solid electrolyte composition) in the solid electrolyte composition. The moisture content can be obtained by Karl Fischer titration after filtering the solid electrolyte composition the through a membrane filter having a pore size of 0.02 μm.

Hereinafter, the components that are included in the solid electrolyte composition according to the embodiment of the present invention and components that may be included therein will be described.

<(A) Inorganic Solid Electrolyte>

In the present invention, the inorganic solid electrolyte is an inorganic solid electrolyte, and the solid electrolyte refers to a solid-form electrolyte capable of migrating ions therein. The inorganic solid electrolyte is clearly distinguished from organic solid electrolytes (polymer electrolytes such as polyethylene oxide (PEO) and organic electrolyte salts such as lithium bis(trifluoromethanesulfonyl)imide (LiTFSI)) since the inorganic solid electrolyte does not include any organic matter as a principal ion conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, LiFSI, LiCl, and the like). The inorganic solid electrolyte is not particularly limited as long as it has ion conductivity of a metal belonging to Group 1 or Group 2 in the periodic table and generally does not have electron conductivity.

In the present invention, the inorganic solid electrolyte has ion conductivity of a metal belonging to Group 1 or Group 2 in the periodic table. The inorganic solid electrolyte can be appropriately selected from solid electrolyte materials to be applied to this kind of products and used. Representative examples of the inorganic solid electrolyte include (i) a sulfide-based inorganic solid electrolyte and (ii) an oxide-based inorganic solid electrolyte. From the viewpoint of a high ion conductivity and easiness in joining interfaces between particles, a sulfide-based inorganic solid electrolyte is preferable.

In a case where an all-solid state secondary battery according to the embodiment of the present invention is an all-solid state lithium ion secondary battery, the inorganic solid electrolyte preferably has ion conductivity of lithium ions.

(i) Sulfide-Based Inorganic Solid Electrolyte

The sulfide-based inorganic solid electrolyte is preferably a compound that contains a sulfur atom, has ion conductivity of a metal belonging to Group 1 or Group 2 in the periodic table, and has electron-insulating properties. The sulfide-based inorganic solid electrolyte is preferably an inorganic solid electrolyte that contains at least Li, S, and P as elements and has lithium ion conductivity. However, the sulfide-based inorganic solid electrolyte may include elements other than Li, S, and P depending on the purposes or cases.

Examples of the sulfide-based inorganic solid electrolyte include a lithium ion-conductive sulfide-based inorganic solid electrolyte satisfying a composition represented by the following Formula (1).

Lₐ₁M_{b1}P_{c1}S_{d1}Aₑ₁ Formula (I)

In the formula, L represents an element selected from Li, Na, or K and is preferably Li. M represents an element selected from B, Zn, Sn, Si, Cu, Ga, Sb, Al, or Ge.

A represents an element selected from I, Br, Cl, or F, and a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the ratios of raw material compounds blended to manufacture the sulfide-based inorganic solid electrolyte as described below.

The sulfide-based inorganic solid electrolyte may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case where the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂S₁₂. Mixing ratios of the respective raw materials do not matter. Examples of a method for synthesizing the sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing steps.

(ii) Oxide-Based Inorganic Solid Electrolyte

The oxide-based inorganic solid electrolyte is preferably a compound that contains an oxygen atom, has ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited, but realistically 1×10⁻¹ S/cm or less.

Specific examples of the compound include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤yb≤4, zb satisfies 1≤zb≤4, mb satisfies 0≤mb≤2, and nb satisfies 5≤nb≤20.), Li_{xc}B_{yc}M^{cc}_{zc}O_{nc} (M^{cc} is at least one element of C, S, Al, Si, Ga, Ge, In, or Sn, xc satisfies 0<xc≤5, yc satisfies 0<yc≤1, zc satisfies 0<zc≤1, and nc satisfies 0<nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li₍₃₋₂ₓₑ₎M^{ee}ₓₑD^{ee}O (xe represents a number of 0 or more and 0.1 or less, M^{ee} represents a divalent metal atom, D^{ee} represents a halogen atom or a combination of two or more halogen atoms), Li_{xf}Si_{yf}O_{zf} (1≤xf≤5, 0<yf≤3, 1≤zf≤10), Li_{xg}S_{yg}O_{zg} (1≤xg≤3, 0<yg≤2, 1≤zg≤10), Li₃BO₃-L₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super ionic conductor (LISICON)-type crystal structure, La_{0.55}Li_{0.35}TiO₃ having a perovskite type crystal structure, LiTi₂P₃O₁₂ having a natrium super ionic conductor (NASICON)-type crystal structure, Li_{1+xh+yh}(Al, Ga)ₓₕ(Ti, Ge)₂₋ₓₕSi_{yh}P_{3-yh}O₁₂ (0≤xh≤1, 0≤yh≤1), Li₇La₃Zr₂O₁₂ (LLZ) having a garnet-type crystal structure. In addition, phosphorus compounds containing Li, P, and 0 are also desirable. Examples thereof include lithium phosphate (Li₃PO₄) and LiPON in which some of oxygen atoms in lithium phosphate are substituted with nitrogen atoms, LiPOD¹ (D¹ is at least one element selected from Ti, V, Cr, Mn, Fe, Co, Ni, Cu, Zr, Nb, Mo, Ru, Ag, Ta, W, Pt, Au, or the like). It is also possible to preferably use LiA¹ON (A¹ represents at least one element selected from Si, B, Ge, Al, C, Ga, or the like) and the like.

The inorganic solid electrolyte is preferably in the form of particles. In this case, the average particle size (volume average particle size) of the inorganic solid electrolyte is not particularly limited, but is preferably 0.01 μm or more and more preferably 0.1 μm or more. The upper limit is preferably 100 μm or less and more preferably 50 μm or less. The average particle size of the inorganic solid electrolyte is measured in the following order. The inorganic solid electrolyte particles are diluted using water (heptane in a case where the inorganic solid electrolyte is unstable in water) in a 20 mL sample bottle to prepare 1 mass % of a dispersion liquid. The diluted dispersion specimen is irradiated with 1 kHz ultrasonic waves for 10 minutes and is then immediately used for testing. The volume average particle size is obtained by acquiring data 50 times using this dispersion liquid specimen, a laser diffraction/scattering particle size distribution analyzer LA-920 (trade name, manufactured by Horiba Ltd.), and a quartz cell for measurement at a temperature of 25° C. Other detailed conditions and the like can be found in JIS Z8828: 2013 “Particle Size Analysis-Dynamic Light Scattering” as necessary. For each level, five specimens are prepared and the average value thereof is adopted.

As the inorganic solid electrolyte, one kind may be used alone, or two or more kinds may be used in combination.

From the viewpoints of dispersibility, a reduction in interface resistance, and binding properties, the content of the inorganic solid electrolyte in the solid electrolyte composition is not particularly limited and is preferably 5 mass % or higher, more preferably 70 mass % or higher, and still more preferably 90 mass % or higher with respect to 100 mass % of the solid content. From the same viewpoint, the upper limit is preferably 99.99 mass % or lower, more preferably 99.95 mass % or lower, and particularly preferably 99.9 mass % or lower. Here, in a case where the solid electrolyte composition contains an active material described below, the content of the inorganic solid electrolyte in the solid electrolyte composition refers to the total content of the inorganic solid electrolyte and the active material.

In the present invention, the solid content (solid component) refers to components that neither volatilize nor evaporate and disappear in a case where the solid electrolyte composition is dried at 150° C. for 6 hours in a nitrogen atmosphere at a pressure of 1 mmHg. Typically, the solid content refers to components other than a dispersion medium described below.

<(B) Binder>

The solid electrolyte composition according to the embodiment of the present invention includes the binder (B) including the polymer (hereinafter, also referred to as “polymer b”) that includes a structure having 6 or more carbon atoms represented by Formula (H-1) or (H-2) described below. The binder (B) may include a polymer other than the above-described polymer b. The content of the polymer b with respect to all the polymers in the binder is preferably 80 mass % or higher and more preferably 90 mass % or higher and may be 100 mass %.

In the solid electrolyte composition (for example, in the dispersion medium), the binder may be dissolved or may be dispersed while maintaining in the form of particles and is preferably dispersed. In a case where the binder is dispersed, the solid electrolyte composition according to the embodiment of the present invention includes not only an aspect where the binder includes the dispersion medium in a state where the form of particles and the average particle size are maintained but also an aspect where a part of the binder is dissolved in the dispersion medium within a range where the effects of the present invention do not deteriorate.

It is preferable that the binder is formed of polymer particles. In this case, the shape of the polymer particles is not particularly limited as long as it is a particle shape, and may be a spherical shape or an unstructured shape in the solid electrolyte composition, a solid electrolyte-containing sheet, or, a constituent layer of an all-solid state secondary battery.

In a case where the binder is formed of polymer particles, the average particle size of the binder is preferably 5 nm to 10 μm. As a result, the dispersibility of the solid electrolyte composition, the binding properties between the solid particles, and the ion conductivity can be improved. From the viewpoint of further improving the dispersibility, the binding properties, and the ion conductivity, the average particle size is preferably 10 nm to 5 μm, more preferably 15 nm to 1 μm, and still more preferably 20 nm to 0.5 μm.

The average particle size of the binder can be measured using the same method as that of the inorganic solid electrolyte.

The average particle size of the binder in a constituent layer of an all-solid state secondary battery can be measured, for example, by disassembling the battery to peel off the constituent layer including the binder, measuring the average particle size of the constituent layer, and excluding a measured value of the average particle size of particles other than the binder obtained in advance from the average particle size of the constituent layer.

The average particle size of the binder can be adjusted to a desired particle size by adjusting, for example, the kind of the dispersion medium used for preparing a binder dispersion liquid, the kind of a component in the polymer of the binder (for example, in a case where a component derived from a macromonomer is incorporated into the polymer forming the binder, the content or the like of the component in the polymer is adjusted), and the like.

The mass average molecular weight of the polymer in the binder is not particularly limited and is preferably 5,000 or more, more preferably 10,000 or higher, and still more preferably 30,000 or higher. The upper limit is preferably 10,000,000 or lower, more preferably 1,000,000 or lower, and still more preferably 200,000 or lower.

The binder is not particularly limited as long as it is formed to include a polymer that includes at least one structural unit having 6 or more carbon atoms represented by Formula (H-1) or (H-2) described below. As the polymer in the binder, a polymer that is typically used in a solid electrolyte composition for an all-solid state secondary battery can be used, except that it includes at least one structural unit having 6 or more carbon atoms represented by Formula (H-1) or (H-2) described below. That is, a polymer that includes at least one structural unit having 6 or more carbon atoms represented by Formula (H-1) or (H-2) described below can be used. For example, a sequential polymerization type polymer or an addition polymerization type polymer can be used, and it is preferable that an addition polymerization type polymer is used. Specific example of the polymer in the binder include a polyurethane resin, a polyurea resin, a polyamide resin, a polyimide resin, a polyester resin, a typical polyether resin, a polycarbonate resin, a cellulose derivative resin, a fluorine-containing resin, a hydrocarbon-based thermoplastic resin, a polyvinyl resin, and a (meth)acrylic resin. Among these, a polyurea resin, a polyurethane resin, or a (meth)acrylic resin is preferable, and a (meth)acrylic resin is more preferable.

In the present invention, the polymer in the binder is preferably a polymer (1) or (2).

(1) A polymer that includes a structural unit having 6 or more carbon atoms, preferably 1 to 6 carbon atoms, more preferably 1 or 2 atoms, and still more preferably 1 carbon atom represented by Formula (H-1)

(2) A polymer that includes a structural unit having 6 or more carbon atoms, preferably 1 to 1000 carbon atoms, more preferably 1 to 100 atoms, and still more preferably 1 to 20 carbon atoms represented by Formula (H-2)

In the polymer (1), the dispersibility of the solid electrolyte composition can be further improved.

In the present invention, in a case where the polymer in the binder is a polymer that includes a structural unit having 6 or more carbon atoms represented by Formula (H-1), the above-described polymer may include the above-described structural unit at any one of a main chain or a side chain, preferably at an end portion of the main chain, more preferably at a terminal of the main chain. In a case where the polymer in the binder is a polymer that includes a structural unit having 6 or more carbon atoms represented by Formula (H-2), the above-described polymer may include the above-described structural unit at any one of a main chain or a side chain and preferably at the main chain. In a case where a polymer B-1 synthesized in Examples described below will be described as an example, the structural unit [CH₃OC(CH₃)₂CH₂C(CH₃)(CN)—] having 6 or more carbon atoms represented by Formula (H-1) is bonded to a terminal of an alkylene chain as a main chain.

In the present invention, a main chain of the polymer refers to a linear molecular chain in which all the molecular chains forming the polymer other than the main chain can be considered branched chains or pendant chains to the main chain. This branched chain or pendant chain will also be referred to as “side chain”. In a case where the polymer includes a component derived from a macromonomer, typically, the longest chain among all the molecular chains forming the polymer is the main chain although depending on the mass average molecular weight of the macromonomer. In this case, a functional group at a polymer terminal is not included in the main chain.

In addition, side chains of the polymer refers to molecular chains other than the main chain and include a short molecular chain and a long molecular chain. In the present invention, it is preferable that the side chain of the polymer is a uncrosslinked molecular chain (for example, a graft chain or a pendant chain) without forming a crosslinked structure from the viewpoint of dispersibility and binding properties.

(Addition Polymerization Type Polymer)

In a case where the polymer in the binder is an addition polymerization type polymer such as a polyvinyl resin or a (meth)acrylic resin, a monomer used for addition polymerization will be described. Examples of this monomer (M) include a compound having a polymerizable group (for example, a group having an ethylenically unsaturated bond), for example, various vinyl compounds or (meth)acrylic compounds. In particular, it is preferable that a (meth)acrylic compound is used. A (meth)acrylic compound selected from a (meth)acrylic acid compound, a (meth)acrylic acid ester compound, and a (meth)acrylonitrile compound is more preferable. The number of polymerizable groups in one molecule of the monomer (M) is not particularly limited and is preferably 1 to 4 and more preferably 1.

As the vinyl compound or the (meth)acrylic compound, a compound represented by Formula (b-1) is preferable.

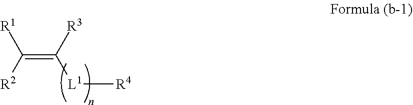

In the formula, R¹ to R³ each independently represents a hydrogen atom, a hydroxy group, a cyano group, a halogen atom, an alkyl group (having preferably 1 to 24 carbon atoms, more preferably 1 to 12 carbon atoms, and still more preferably 1 to 6 carbon atoms), an alkenyl group (having preferably 2 to 24 carbon atoms, more preferably 2 to 12 carbon atoms, and still more preferably 2 to 6 carbon atoms), an alkynyl group (having preferably 2 to 24 carbon atoms, more preferably 2 to 12 carbon atoms, and still more preferably 2 to 6 carbon atoms), or an aryl group (having preferably 6 to 22 carbon atoms and more preferably 6 to 14 carbon atoms). In particular, R¹ to R³ each independently represent preferably a hydrogen atom or an alkyl group, and more preferably a hydrogen atom or a methyl group. In addition, it is preferable that R¹ and R² each independently represent a hydrogen atom.

R⁴ represents a hydrogen atom or a substituent. The substituent that can be used as R⁴ is not particularly limited, and examples thereof include an alkyl group (having preferably 1 to 30 carbon atoms, more preferably 6 to 24 carbon atoms, and still more preferably 8 to 24 carbon atoms; the alkyl group may be a branched but is preferably linear), an alkenyl group (having preferably 2 to 12 carbon atoms and more preferably 2 to 6 carbon atoms), an aryl group (having preferably 6 to 22 carbon atoms and more preferably 6 to 14 carbon atoms), an aralkyl group (having preferably 7 to 23 carbon atoms and more preferably 7 to 15 carbon atoms), a cyano group, a carboxy group, a hydroxy group, a mercapto group, a sulfonate group, a phosphate group, a phosphonate group, an aliphatic heterocyclic group having an oxygen atom (having preferably 2 to 12 carbon atoms and more preferably 2 to 6 carbon atoms), and an amino group (NR^{N1}₂: R^{N1} represents a hydrogen atom or a substituent and preferably a hydrogen atom or an alkyl group having 1 to 3 carbon atoms). In particular, a group having 6 or more carbon atoms is preferable, and an alkyl group, an aryl group, or an aralkyl group having 6 or more carbon atoms is preferable. It is preferable that the group having 6 or more carbon atoms is linear.

The sulfonate group, the phosphate group, and the phosphonate group may be esterified with, for example, an alkyl group having 1 to 6 carbon atoms.

As the aliphatic heterocyclic group having an oxygen atom, for example, an epoxy group-containing group, an oxetane group-containing group, or a tetrahydrofuryl group-containing group is preferable.

L¹ represents a linking group, the linking group is not particularly limited, and examples thereof include an alkylene group having 1 to 6 carbon atoms (having preferably 1 to 3 carbon atoms), an alkenylene group having 2 to 6 carbon atoms (having preferably 2 or 3 carbon atoms), an arylene group having 6 to 24 carbon atoms (having preferably 6 to 10 carbon atoms), an oxygen atom, a sulfur atom, an imino group (—NR^{N}—), a carbonyl group, a phosphate linking group, a phosphonate linking group, and a group relating to a combination thereof. Among these, a —CO—O— group, a —CO—N(R^{N})— group (R^{N} is as described below) is preferable. The above-described linking group may have any substituent. The number of linking atoms and a preferable range of the number of linking atoms are as described below. Examples of the substituent include the substituent T described below. For example, an alkyl group or a halogen atom can be used.

n represents 0 or 1 and preferably 1. In this case, in a case where -(L¹)ₙ-R⁴ represents one substituent (for example, an alkyl group), n represents 0, and R⁴ represents a substituent (alkyl group).

It is preferable that the compound represented by Formula (b-1) is a compound represented by Formula (r-1).

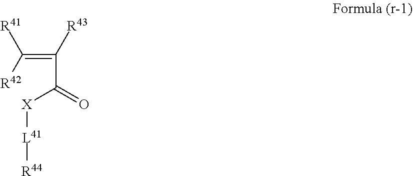

In the formula, R⁴¹ to R⁴³ each independently represent a hydrogen atom, a cyano group, a halogen atom, or an alkyl group (having preferably 1 to 24 carbon atoms, more preferably 1 to 12 carbon atoms, and still more preferably 1 to 6 carbon atoms). R⁴⁴ has the same definition and the same preferable range as R⁴ in Formula (b-1).

X represents an oxygen atom or NR^{N}, and R^{N} represents a hydrogen atom or an alkyl group having 1 to 12 carbon atoms.

L⁴¹ represents a single bond or a linking group. Examples of the linking group include an alkylene group having 1 to 6 carbon atoms (having preferably 1 to 3 carbon atoms), an alkenylene group having 2 to 6 carbon atoms (having preferably 2 or 3 carbon atoms), an arylene group having 6 to 24 carbon atoms (having preferably 6 to 10 carbon atoms), an oxygen atom, a sulfur atom, an imino group (—NR^{N}—), a carbonyl group, a phosphate linking group (—O—P(OH)(O)—O—), a phosphonate linking group (—P(OH)(O)—O—), and a group relating to a combination thereof. Among these, a —CO—O— group, a —CO—N(R^{N})— group (R^{N} is as described above) is preferable.

The above-described linking group may have any substituent. The number of linking atoms and a preferable range of the number of linking atoms are as described below.

Examples of the substituent include the substituent T described below. For example, an alkyl group or a halogen atom can be used.

Examples of a monomer other than the compound represented by Formula (b-1) include “vinyl monomer” described in JP2015-088486A.

Specific examples of the monomer (M) will be shown below but do not intend to limit the present invention. In the following formulae, 1 represents 1 to 1,000,000.

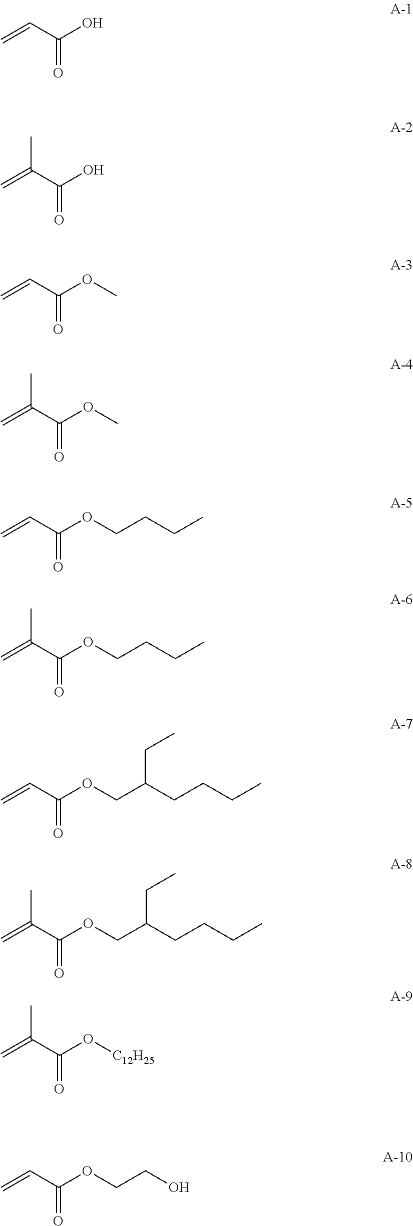

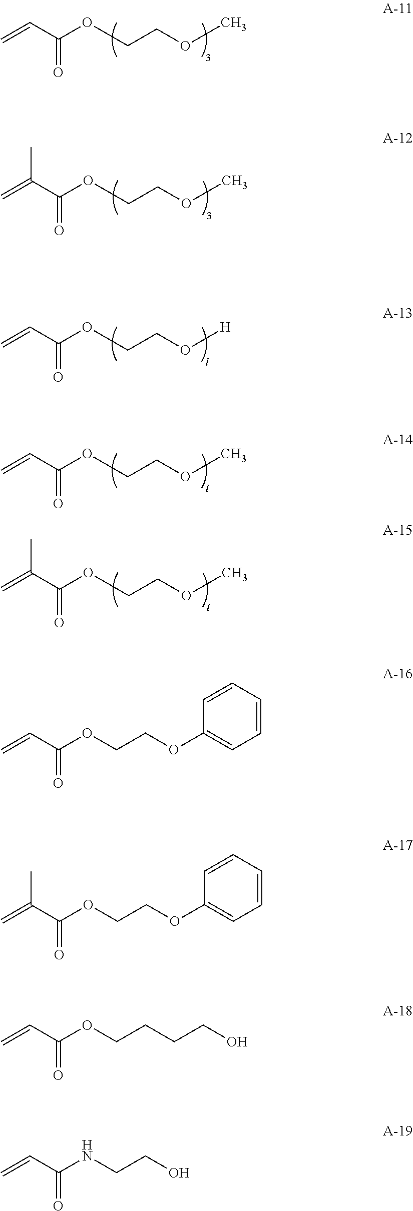

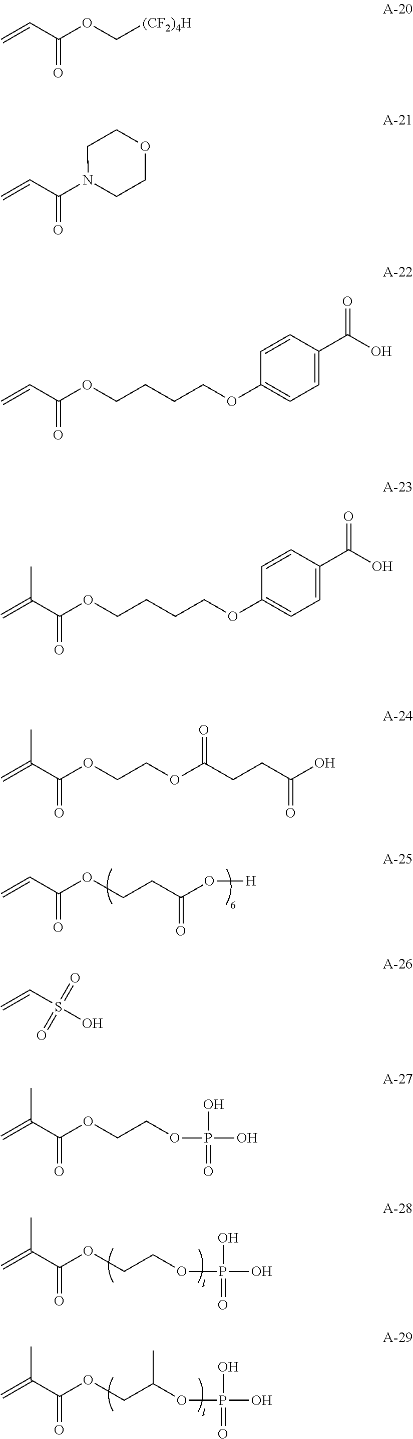

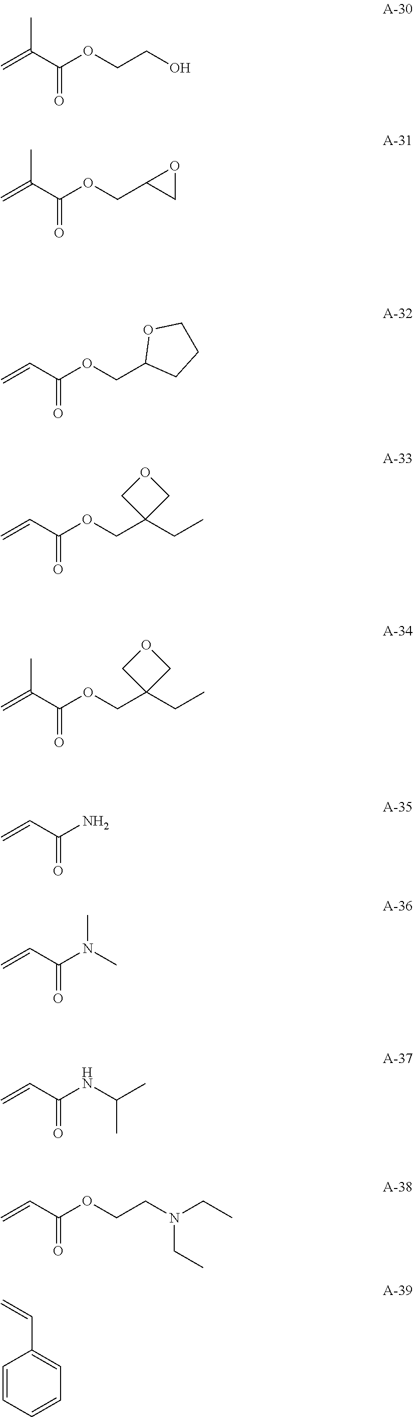

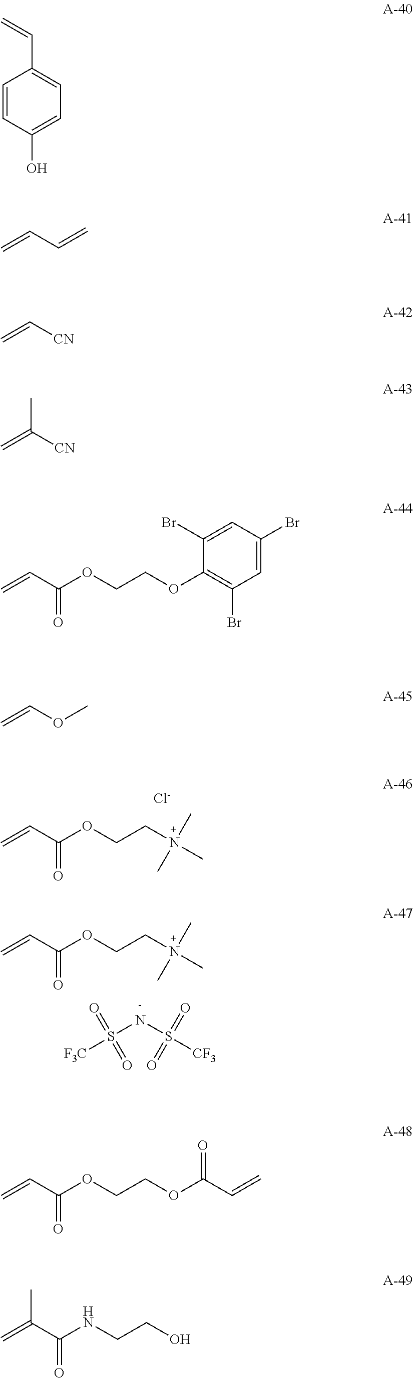

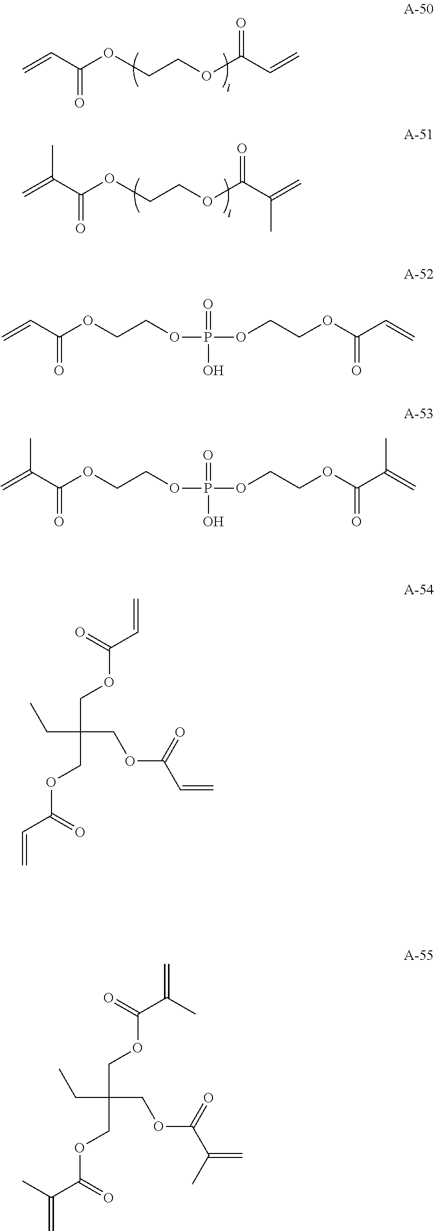

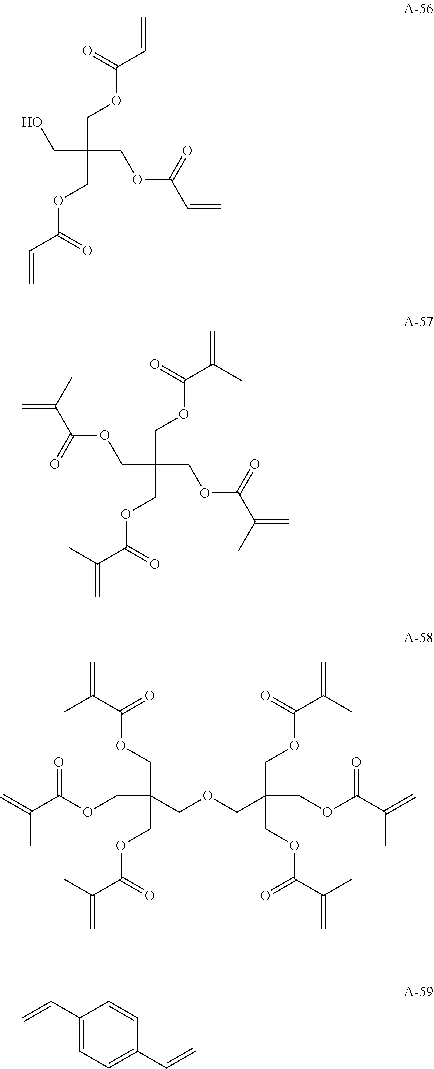

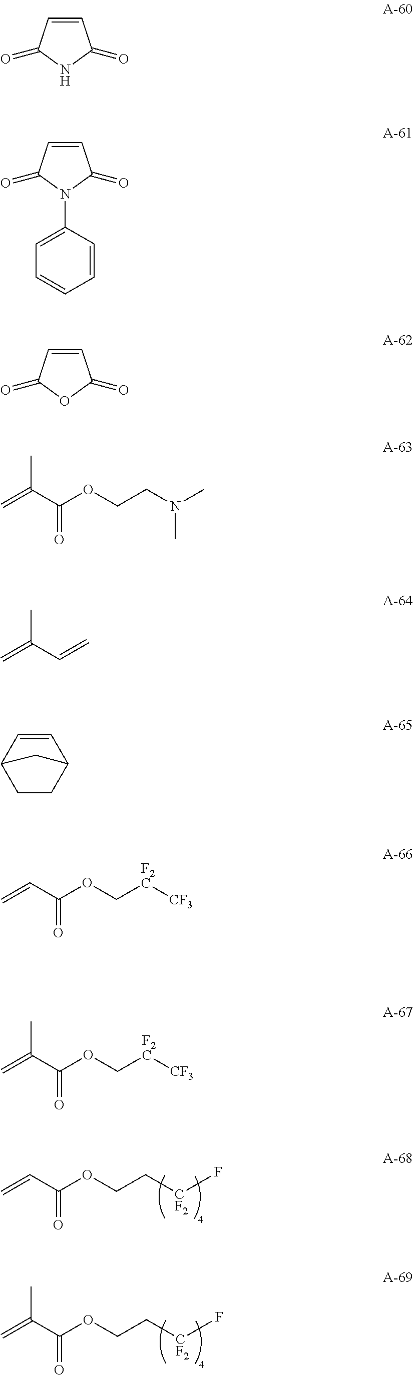

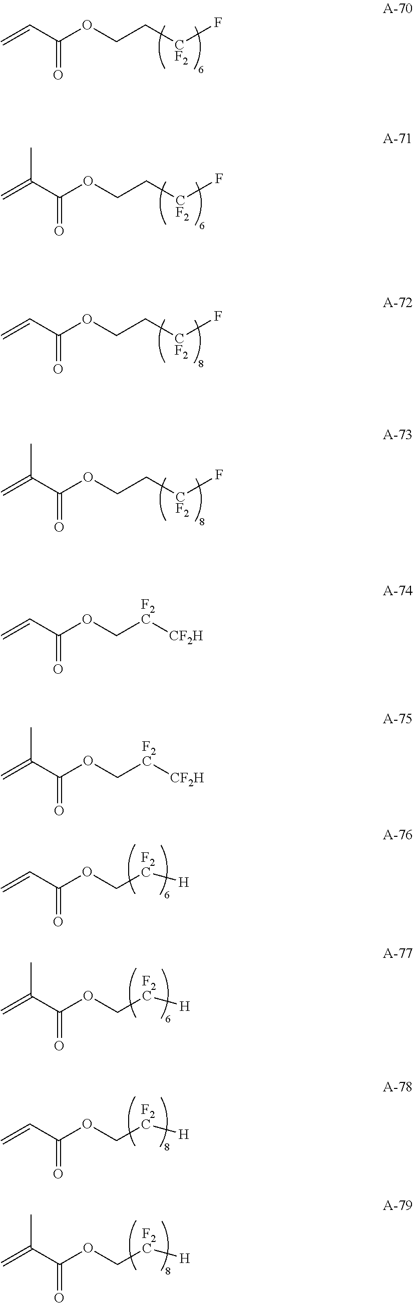

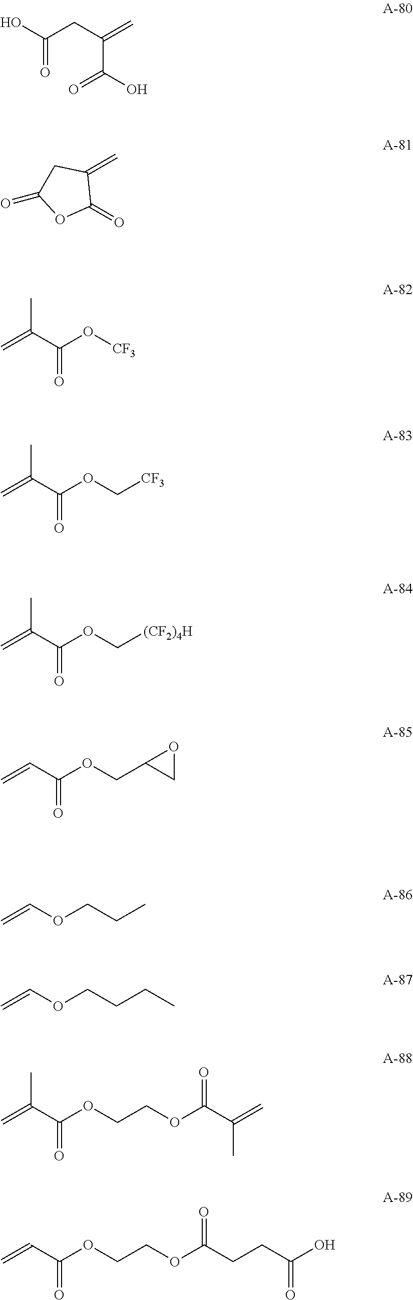

In the present invention, it is preferable that the polymer in the binder includes a repeating unit derived from Formula (r-1), that is, a repeating unit (K) represented by Formula (R-1).

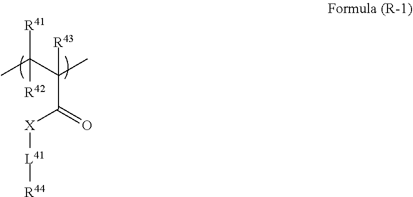

In the formula, R⁴¹ to R⁴⁴, X, and L⁴¹ have the same definitions and the same preferable ranges as those of R⁴¹ to R⁴⁴, X, and L⁴¹ in Formula (r-1).

The content of the above-described repeating unit (K) in the polymer is not particularly limited and is preferably 30 mass % to 99.5 mass %. As a result, a balance between the repeating unit (K) and/or the component (MM) described below can be improved, and the dispersibility of the solid electrolyte composition, the binding properties between the solid particles and the like, and the ion conductivity can be exhibited on a higher level. The content of the repeating unit (K) in the polymer is more preferably 40 mass % or higher, still more preferably 50 mass % or higher, and still more preferably 60 mass % or higher. The upper limit is more preferably 99 mass % or lower, more preferably 98 mass % or lower, still more preferably 95 mass % or lower, and still more preferably 90 mass % or lower.

In a case where the polymer in the binder is an addition polymerization type polymer, it is preferable that the polymer includes a component (MM) derived from a macromonomer having a mass average molecular weight of 1000 or higher.

The mass average molecular weight of the macromonomer is preferably 2,000 or higher and more preferably 3,000 or higher. The upper limit is preferably 500,000 or lower, more preferably 100,000 or lower, and still more preferably 30,000 or lower. In a case where the polymer in the binder includes the component (MM) derived from the macromonomer having a mass average molecular weight in the above-described range, the polymer can be more uniformly dispersed in the dispersion medium.

The macromonomer is not particularly limited as long as it has a mass average molecular weight of 1000 or higher, and is preferably a macromonomer that includes a polymer chain bonded to a polymerizable group such as a group having an ethylenically unsaturated bond. The polymer chain in the macromonomer forms a side chain (graft chain) to the main chain of the polymer.

The polymer chain has an action of improving the dispersibility in the dispersion medium. As a result, in a case where the polymer in the binder is in the form of particles, the polymer is favorably dispersed and thus can cause the inorganic solid electrolyte to be bound to each other without locally or totally covering the solid particles such as the inorganic solid electrolyte. As a result, the solid particles can be adhered to each other without interrupting an electrical connection therebetween. Therefore, it is presumed that an increase in the interface resistance between the solid particles is suppressed. Further, the polymer in the binder includes the polymer chain such that not only an effect of causing the particle binder to be attached to the solid particles but also an effect of twisting the polymer chain can be expected. As a result, it is presumed that suppression in the interface resistance between the solid particles and improvement of binding properties are simultaneously achieved. The molecular weight of the component (MM) can be identified by measuring the mass average molecular weight of the macromonomer incorporated during the synthesis of the polymer in the binder.

—Measurement of Mass Average Molecular Weight—

In the present invention, unless specified otherwise, the molecular weights of the polymer and the macromonomer in the binder refer to mass average molecular weights in terms of standard polystyrene by gel permeation chromatography (GPC). Regarding a measurement method, basically, a value measured using a method under the following condition 1 or condition 2 (preferred) is used. An appropriate eluent may be appropriately selected and used depending on the kind of the polymer or the macromonomer.

(Condition 1)

Column: Two TOSOH TSKgel Super AWM-H's (trade name, manufactured by Tosoh Corporation) connected together

Carrier: 10 mM LiBr/N-methylpyrrolidone

Measurement temperature: 40° C.

Carrier flow rate: 1.0 ml/min

Sample concentration: 0.1 mass %

Detector: refractive index (RI) detector

(Condition 2)

Column: A column obtained by connecting TOSOH TSKgel Super HZM-H, TOSOH TSKgel Super HZ4000, and TOSOH TSKgel Super HZ2000 (all of which are trade names, manufactured by Tosoh Corporation)

Carrier: tetrahydrofuran

Measurement temperature: 40° C.

Carrier flow rate: 1.0 ml/min

Sample concentration: 0.1 mass %

Detector: refractive index (RI) detector

The SP value of the component (MM) is not particularly limited and is preferably 10 or lower and more preferably 9.5 or lower. The lower limit value is not particularly limited, but is practically 5 or more. The SP value is an index indicating a property of being dispersed in an organic solvent. In addition, by adjusting the component (MM) to have a specific molecular weight or higher and preferably to adjust the SP value to be the above-described SP value or higher, the binding properties with the solid particles can be improved, affinity to a solvent can be improved, and thus the polymer can be stably dispersed.

—Definition of SP Value—

Unless specified otherwise, the SP value in the present invention is obtained using a Hoy method (H. L. Hoy Journal of Painting, 1970, Vol. 42, 76-118). In addition, the unit of the SP value is not shown but is ca^{1/2} m^{-3/2}. The SP value of the component (MM) is not substantially different from the SP value of the macromonomer and may be evaluated using the SP value of the macromonomer.

The polymerizable group in the macromonomer is not particularly limited, and the details will be described below. Examples of the polymerizable group include various vinyl groups and (meth)acryloyl groups. Among these, a (meth)acryloyl group is preferable.

The polymer chain in the macromonomer A is not particularly limited, and a typical polymer component can be used. Examples of the polymer chain include a chain of a (meth)acrylic resin, a chain of a polyvinyl resin, a polysiloxane chain, a polyalkylene ether chain, and a hydrocarbon chain. Among these, a chain of a (meth)acrylic resin or a polysiloxane chain is preferable.

It is preferable that the chain of a (meth)acrylic resin includes a component derived from a (meth)acrylic compound selected from a (meth)acrylic acid compound, a (meth)acrylic acid ester compound, and a (meth)acrylonitrile compound, and it is more preferable that the chain of a (meth)acrylic resin is a polymer of two or more (meth)acrylic compounds. The polysiloxane chain is not particularly limited, and examples thereof include a siloxane polymer having an alkyl group or an aryl group. Examples of the hydrocarbon chain include a chain consisting of a hydrocarbon-based thermoplastic resin.

In addition, it is preferable that the component forming the above-described polymer chain includes a polymerizable double bond and a linear hydrocarbon structural unit S having 6 or more carbon atoms (preferably an alkylene group having 6 to 30 carbon atoms and more preferably an alkylene group having 8 to 24 carbon atoms). This way, the component forming the polymer chain includes the linear hydrocarbon structural unit S such that affinity to the dispersion medium is improved and dispersion stability is improved. The linear hydrocarbon structural unit S has the same definition as a linear group among groups having 6 or more carbon atoms in the monomer (M).

It is preferable that the macromonomer has a polymerizable group represented by Formula (b-11). In the following formula, R¹¹ has the same definition as R¹. * represents a binding position.

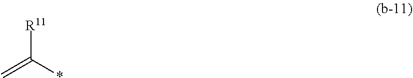

It is preferable that the macromonomer has a polymerizable site represented by any one of Formulae (b-12a) to (b-12c).

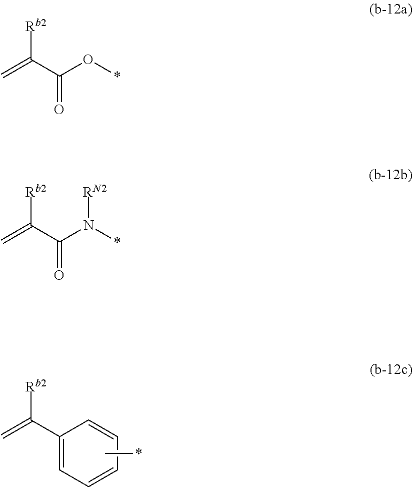

R^{b2} has the same definition as R¹. * represents a binding position. R^{N2} has the same definition as that of R^{N1}. A benzene ring in Formula (b-12c) may be substituted with any substituent T.

The structural unit present before the binding position of * is not particularly limited as long as the molecular weight as a macromonomer is satisfied. In particular, the polymer chain (preferably bonded through a linking group) is preferable. In this case, the linking group and the polymer chain may each independently have the substituent T, for example, a halogen atom (fluorine atom).

In the present invention, the number of atoms forming the linking group is preferably 1 to 36, more preferably 1 to 24, still more preferably 1 to 12, and still more preferably 1 to 6. The number of linking atom in the linking group is preferably 10 or less and more preferably 8 or less. The lower limit is 1 or more. The number of linking atoms refers to the minimum number of atoms that connect predetermined structural units. For example, in the case of —CH₂—C(═O)—O—, the number of atoms forming the linking group is 6, but the number of linking atoms is 3.

It is preferable that the macromonomer is a compound represented by Formula (b-13a).

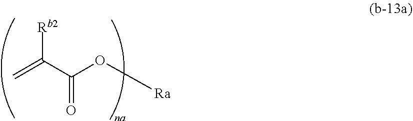

R^{b2} has the same definition as R¹.

na is not particularly limited and is preferably an integer of 1 to 6, more preferably 1 or 2, and still more preferably 1.

In a case where na represents 1, Ra represents a substituent. In a case where na represents 2 or more, Ra represents a linking group.

The substituent that can be used as Ra is not particularly limited and is preferably the above-described polymer chain and more preferably the chain of a (meth)acrylic resin or the polysiloxane chain.

Ra may be directly bonded to an oxygen atom (—O—) in Formula (b-13a) but is preferably bonded to an oxygen atom (—O—) in Formula (b-13a) through a linking group. The linking group is not particularly limited, and examples thereof include a linking group through which the polymerizable group and the polymer chain are linked.

In a case where Ra represents a linking group, the linking group is not particularly limited. For example, an alkane linking group having 1 to 30 carbon atoms, a cycloalkane linking group having 3 to 12 carbon atoms, an aryl linking group having 6 to 24 carbon atoms, a heteroaryl linking group having 3 to 12 carbon atoms, an ether group, a sulfide group, a phosphinidene group (—PR—: R represents a hydrogen atom or an alkyl group having 1 to 6 carbon atoms), a silylene group (—SiRR′—: R and R′ represent a hydrogen atom or an alkyl group having 1 to 6 carbon atoms), a carbonyl group, an imino group (—NR^{N1}—: R^{N1} represents a hydrogen atom or a substituent, and preferably a hydrogen atom, an alkyl group having 1 to 6 carbon atoms, or an aryl group having 6 to 10 carbon atoms), or a combination thereof is preferable.

Examples of a macromonomer other than the above-described macromonomer include “vinyl monomer (X)” described in JP2015-088486A.

Examples of the substituent T are as follows:

an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, or 1-carboxymethyl); an alkenyl group (preferably an alkenyl group having 2 to 20 carbon atoms, for example, vinyl, allyl, or oleyl); an alkynyl group (preferably an alkynyl group having 2 to 20 carbon atoms, for example, ethynyl, butadiynyl, or phenyl-ethynyl); a cycloalkyl group (preferably a cycloalkyl group having 3 to 20 carbon atoms, for example, cyclopropyl, cyclopentyl, cyclohexyl, or 4-methylcyclohexyl); an aryl group (preferably an aryl group having 6 to 26 carbon atoms, for example, phenyl, 1-naphthyl, 4-methoxyphenyl, 2-chlorophenyl, or 3-methylphenyl); a heterocyclic group (preferably a heterocyclic group having 2 to 20 carbon atoms and more preferably a 5- or 6-membered heterocyclic group having at least one oxygen atom, sulfur atom, or nitrogen atom; the heterocyclic group includes an aromatic heterocyclic group and an aliphatic heterocyclic group; for example, a tetrahydropyran ring group, a tetrahydrofuran ring group, 2-pyridyl, 4-pyridyl, 2-imidazolyl, 2-benzimidazolyl, 2-thiazolyl, or 2-oxazolyl); an alkoxy group (preferably an alkoxy group having 1 to 20 carbon atoms, for example, methoxy, ethoxy, isopropyloxy, or benzyloxy); an aryloxy group (preferably an aryloxy group having 6 to 26 carbon atoms, for example, phenoxy, 1-naphthyloxy, 3-methylphenoxy, or 4-methoxyphenoxy); a heterocyclic oxy group (a group in which an —O— group is bonded to the above-described heterocyclic group), an alkoxycarbonyl group (preferably an alkoxycarbonyl group having 2 to 20 carbon atoms, for example, ethoxycarbonyl or 2-ethylhexyloxycarbonyl); an aryloxycarbonyl group (preferably an aryloxycarbonyl group having 6 to 26 carbon atoms, for example, phenoxycarbonyl, 1-naphthyloxycarbonyl, 3-methylphenoxycarbonyl, or 4-methoxyphenoxycarbonyl); an amino group (preferably an amino group having 0 to 20 carbon atoms, an alkylamino group, or an arylamino group, for example, amino (—NH₂—), N,N-dimethylamino, N,N-diethylamino, N-ethylamino, or anilino); a sulfamoyl group (preferably a sulfamoyl group having 0 to 20 carbon atoms, for example, N,N-dimethylsulfamoyl or N-phenylsufamoyl); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, acetyl, propionyl, butyryl, octanoyl, hexadecanoyl, acryloyl, methacryloyl, crotonoyl, benzoyl, naphthoyl, or nicotinoyl); an acyloxy group (an alkylcarbonyloxy group, an alkenylcarbonyloxy group, an alkynylcarbonyloxy group, an arylcarbonyloxy group, or a heterocyclic carbonyloxy group, preferably an acyloxy group having 1 to 20 carbon atoms, for example, acetyloxy, propionyloxy, butyryloxy, octanoyloxy, hexadecanoyloxy, acryloyloxy, methacryloyloxy, crotonoyloxy, benzoyloxy, naphthoyloxy, or nicotinoyloxy); an aryloyloxy group (preferably an aryloyloxy group having 7 to 23 carbon atoms, for example, benzoyloxy); a carbamoyl group (preferably a carbamoyl group having 1 to 20 carbon atoms, for example, N,N-dimethylcarbamoyl or N-phenylcarbamoyl); an acylamino group (preferably an acylamino group having 1 to 20 carbon atoms, for example, acetylamino or benzoylamino); an alkylthio group (preferably an alkylthio group having 1 to 20 carbon atoms, for example, methylthio, ethylthio, isopropylthio, or benzylthio); an arylthio group (preferably an arylthio group having 6 to 26 carbon atoms, for example, phenylthio, 1-naphthylthio, 3-methylphenylthio, or 4-methoxyphenylthio); a heterocyclic thio group (a group in which an —S— group is bonded to the above-described heterocyclic group), an alkylsulfonyl group (preferably an alkylsulfonyl group having 1 to 20 carbon atoms, for example, methylsulfonyl or ethylsulfonyl), an arylsulfonyl group (preferably an arylsulfonyl group having 6 to 22 carbon atoms, for example, benzenesulfonyl), an alkylsilyl group (preferably an alkylsilyl group having 1 to 20 carbon atoms, for example, monomethylsilyl, dimethylsilyl, trimethylsilyl, or triethylsilyl); an arylsilyl group (preferably an arylsilyl group having 6 to 42 carbon atoms, for example, triphenylsilyl), a phosphoryl group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a sulfo group (sulfonate group), a hydroxy group, a sulfanyl group, a cyano group, and a halogen atom (for example, a fluorine atom, a chlorine atom, a bromine atom, or an iodine atom), R^{P} represents a hydrogen atom or a substituent (preferably a group selected from the substituent T).

In addition, each exemplary group of the substituent T may be further substituted with the substituent T.

In a case where a compound or a substituent, a linking group, or the like includes, for example, an alkyl group, an alkylene group, an alkenyl group, an alkenylene group, an alkynyl group, and/or an alkynylene group, these groups may be cyclic or chained, may be linear or branched.

The content of the component (MM) in the polymer is not particularly limited and is preferably 1 mass % to 50 mass %. The content of the component (MM) in the polymer is more preferably 3 mass % or higher and still more preferably 5 mass % or higher. The upper limit is more preferably 50 mass % or lower, more preferably 45 mass % or lower, still more preferably 40 mass % or lower, and still more preferably 30 mass % or lower.

It is preferable that a component in the addition polymerization type polymer does not include two or more polymerizable sites that can form a polymer chain. That is, it is preferable that a polymerizable compound having two or more polymerizable groups in one molecule is not used as a polymerizable compound forming the polymer. This polymer is a linear polymer having a main chain with a linear structure. In the present invention, the polymer not including a component represents not only an aspect where the content of the component in the polymer is 0 mass % but also an aspect where the polymer includes the component within a range where the effects of the present invention do not deteriorate (for example, the content thereof in the polymer is 2 mass % or lower).

In the present invention, the polymer in the binder (B) is a polymer that includes at least one structural unit having 6 or more carbon atoms represented by Formula (H-1) or (H-2).

In the present invention, the polymer including the above-described structural unit represents both an aspect where the above-described structural unit is directly bonded to a polymer skeleton and an aspect where the above-described structural unit is bonded to a polymer skeleton through a linking group. Examples of the linking group include an oxygen atom, a —CO—O— bond, an —O—CO—O— bond, and a group including a combination of the atom or the bond and an alkylene group (preferably having 1 or 2 carbon atoms).

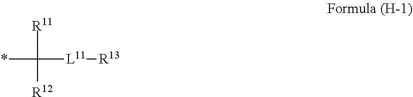

In the formula. R¹¹ and R¹² represents a cyano group, an alkyl group, an alkyloxycarbonyl group, an alkylcarbonyloxy group, a 2-imidazolin-1-yl group, or an aryl group. R¹³ represents a hydrogen atom, an alkyl group, a hydroxy group, a carboxy group, a 2-imidazolin-1-yl group, or an aryl group. L¹¹ represents a single bond, an alkylene group having 1 to 6 carbon atoms, an alkenylene group having 2 to 6 carbon atoms, an arylene group having 6 to 24 carbon atoms, an oxygen atom, a sulfur atom, —N(R^{N})—, a carbonyl group, a silane linking group, an imine linking group (—C(═NR^{N1})—), a phosphate linking group (—O—P(OH)(O)—O—), a phosphonate linking group (—P(OH)(O)—O—), or a group including a combination of two or more among the above-described groups, atoms, and linking groups, (preferably a combination of 2 to 4 among the above-described groups, atoms, and linking groups). R^{N} represents a hydrogen atom or an alkyl group having 1 to 12 carbon atoms. * represents a binding site to a polymer main body. That is, the structural unit represented by Formula (H-1) is bonded to * and incorporated into the polymer. R¹¹ to R¹³ may be linked to each other to form a ring. The structural unit having 6 or more carbon atoms represented by Formula (H-1) does not include “—O—O—” and “—O—S—”.

It is preferable that R¹¹ and R¹² represent a cyano group, an alkyl group, or an alkylcarbonyloxy group.

It is preferable that L¹¹ represents a single bond, an alkylene group having 1 to 6 carbon atoms, —N(R^{N})—, a carbonyl group, an imine linking group, or a group including a combination of two or more among the above-described groups and linking groups.

The alkyl group may be chained or cyclic, and the number of carbon atoms in the chained alkyl group is preferably 1 to 16, more preferably 1 to 6, and still more preferably 1. The number of carbon atoms in the cyclic alkyl group is preferably 4 to 12 and more preferably 6. Specific examples of the alkyl group include methyl, ethyl, propyl, i-propyl, t-butyl, pentyl, and cyclohexyl.

As the alkyl group in the alkyloxycarbonyl group and the alkylcarbonyloxy group, the above-described alkyl group can be adopted.

The number of carbon atoms in the aryl group is preferably 6 to 15 and more preferably 6 to 10, and specific examples thereof include phenyl and naphthyl. The aryl group may have the above-described substituent T.

The number of carbon atoms in the silane linking group is preferably 1 to 10 and more preferably 2 to 4, and specific examples thereof include —Si(CH₃)₂—.

The alkylene group having 1 to 6 carbon atoms and the alkenylene group having 2 to 6 carbon atoms represented by L¹ may be linear or branched. In addition, the alkylene group having 3 or more carbon atoms and the alkenylene group having 3 or more carbon atoms may be cyclic.

The number of carbon atoms in the arylene group having 6 to 24 carbon atoms represented by L¹¹ is more preferably 6 to 10.

The alkyl group represented by R^{N} may be linear or branched. It is preferable that R^{N} represents a hydrogen atom.

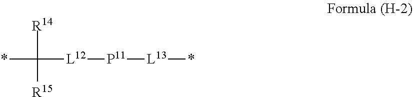

In the formula, R¹⁴ and R¹⁵ represents a cyano group, an alkyl group, an alkyloxycarbonyl group, an alkylcarbonyloxy group, a 2-imidazolin-1-yl group, or an aryl group. L¹² and L¹³ each independently represent a single bond, an alkylene group having 1 to 6 carbon atoms, an alkenylene group having 2 to 6 carbon atoms, an arylene group having 6 to 24 carbon atoms, an oxygen atom, a sulfur atom, —N(R^{N})—, a carbonyl group, a silane linking group, an imine linking group, a phosphate linking group, a phosphonate linking group, or a group including a combination of two or more among the above-described groups, atoms, and linking groups (preferably a combination of 2 to 5 among the above-described groups, atoms, and linking groups). P¹¹ represents a polyalkyleneoxy group or a polyalkoxysilyl group. R^{N} represents a hydrogen atom or an alkyl group having 1 to 12 carbon atoms. * represents a binding site to a polymer main body. R¹⁴ and R¹⁵ may be linked to each other to form a ring. The structural unit having 6 or more carbon atoms represented by Formula (H-2) does not include “—O—O—” and “—O—S—”.

It is preferable that R¹⁴ and R¹⁵ each independently represent a cyano group or an alkyl group.

It is preferable that L¹² and L¹³ represents a single bond, an alkylene group having 1 to 6 carbon atoms, an oxygen atom, a carbonyl group, an silane linking group, or a group including a combination of two or more among the above-described groups, atoms, and linking groups.

Preferable ranges and specific examples of the alkyl group, the alkyloxycarbonyl group, the alkylcarbonyloxy group, the aryl group, and the silane linking group are as described above.

The alkylene group having 1 to 6 carbon atoms and the alkenylene group having 2 to 6 carbon atoms represented by L¹² and L¹³ may be linear or branched.

The number of carbon atoms in the arylene group having 6 to 24 carbon atoms represented by L¹² and L¹³ is more preferably 6 to 10.

The molecular weight of the polyalkyleneoxy group or the polyalkoxysilylene group is preferably 100 to 100000 and more preferably 300 to 30000.

It is preferable that the structural unit represented by Formula (H-1) is a structural unit represented by Formula (H-3), and it is preferable that the structural unit represented by Formula (H-2) is a structural unit represented by Formula (H-4).

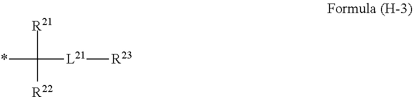

In the formula, R²¹ represents a methyl group, a cyano group, an alkyloxycarbonyl group, an alkylcarbonyloxy group, or a 2-imidazolin-1-yl group. R²² represents an alkyl group having 1 to 6 carbon atoms, a cyano group, an alkyloxycarbonyl group, or an alkylcarbonyloxy group. R²³ represents a cycloalkyl group, a methoxy group, a hydroxy group, a carboxy group, a 2-imidazolin-1-yl group, or an aryl group, and in a case where R²³ represents a cycloalkyl group, R²³ may linked to R²¹. L²¹ represents a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups. R^{N} represents a hydrogen atom or an alkyl group having 1 to 12 carbon atoms. “L²¹-R²³” does not represent “an alkylene group having 1 to 6 carbon atoms—an aryl group”. R²¹ and R²² may be linked to each other to form a ring. * represents a binding site to a polymer main body.

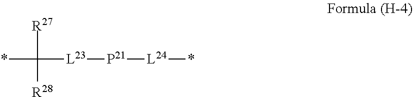

In the formula, R²⁷ and R²⁸ each independently represent a cyano group, an alkyl group having 1 to 6 carbon atoms, an alkyloxycarbonyl group, or an alkylcarbonyloxy group. L²³ and L²⁴ each independently represent a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups. R^{N} represents a hydrogen atom or an alkyl group having 1 to 12 carbon atoms. P²¹ represents a polyalkyleneoxy group or a polyalkoxysilylene group. * represents a binding site to a polymer main body. R²⁷ and R²⁸ may be linked to each other to form a ring.

It is preferable that the structural unit represented by Formula (H-2) is a structural unit represented by Formula (H-5).

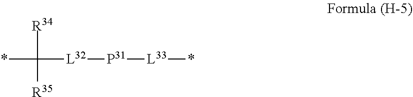

In the formula, R³⁴ and R³⁵ each independently represent a cyano group, an alkyl group having 1 to 6 carbon atoms, an alkyloxycarbonyl group, or an alkylcarbonyloxy group. L³² and L³³ each independently represent a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups. P³¹ represents a polyalkyleneoxy group or a polyalkoxysilylene group having a mass average molecular weight of 1000 or higher. R^{N} represents a hydrogen atom or an alkyl group having 1 to 12 carbon atoms. * represents a binding site to a polymer main body. R³⁴ and R³⁵ may be linked to each other to form a ring.

The content of the structural unit having 6 or more carbon atoms represented by Formula (H-1) or (H-2) is not particularly limited and is preferably 1 mass % or higher, more preferably 2 mass % or higher, and still more preferably 3 mass % or higher with respect to the mass of the polymer in the binder (B). The upper limit is preferably 50 mass % or lower, more preferably 30 mass % or lower, still more preferably 10 mass % or lower, and still more preferably 8 mass % or lower. By adjusting the content of the above-described structural unit to be in the above-described range, the affinity to the inorganic solid electrolyte and the dispersibility in the dispersion medium are excellent.

The polymer in the binder (B) may include other components in addition to the above-described component within a range where the effects of the present invention do not deteriorate. The content of the other components in the above-described polymer is, for example, 20 mass % or lower.

The polymer in the binder according to the embodiment of the present invention may be synthesized using a monomer that includes the structural unit having 6 or more carbon atoms represented by Formula (H-1) or (H-2), or the above-described structural unit may be introduced into the above-described polymer using a polymerization initiator (a radical structural unit to be generated) used for the synthesis of the above-described polymer.

The polymerization initiator that can introduce the above-described structural unit into the above-described polymer is not particularly limited as long as it is a polymerization initiator that generates at least one radical structural unit having a partial structure corresponding to the above-described structural unit among well-known polymerization initiators. Examples of the polymerization initiator include a photopolymerization initiator and a thermal polymerization initiator. Among these, a thermal polymerization initiator is preferable. The polymerization initiator may be not only a radical structural unit having a partial structure corresponding to the above-described structural unit but also a polymerization initiator that generates a radical structural unit not having a partial structure corresponding to the above-described structural unit.

In particular, in a case where a polymerization initiator (a polymerization initiator having a polymer chain) that generates the structural unit represented by Formula (H-2) is used, the dispersibility, the binding properties, and the battery characteristics can be satisfied on a high level even in a case where the polymer does not include a macromonomer component.

Hereinafter, specific examples of the thermal polymerization initiator that can introduce the above-described structural unit into the above-described polymer will be described, but the present invention is not limited thereto. Trade names of compounds including a thermal polymerization initiator are partially shown together.

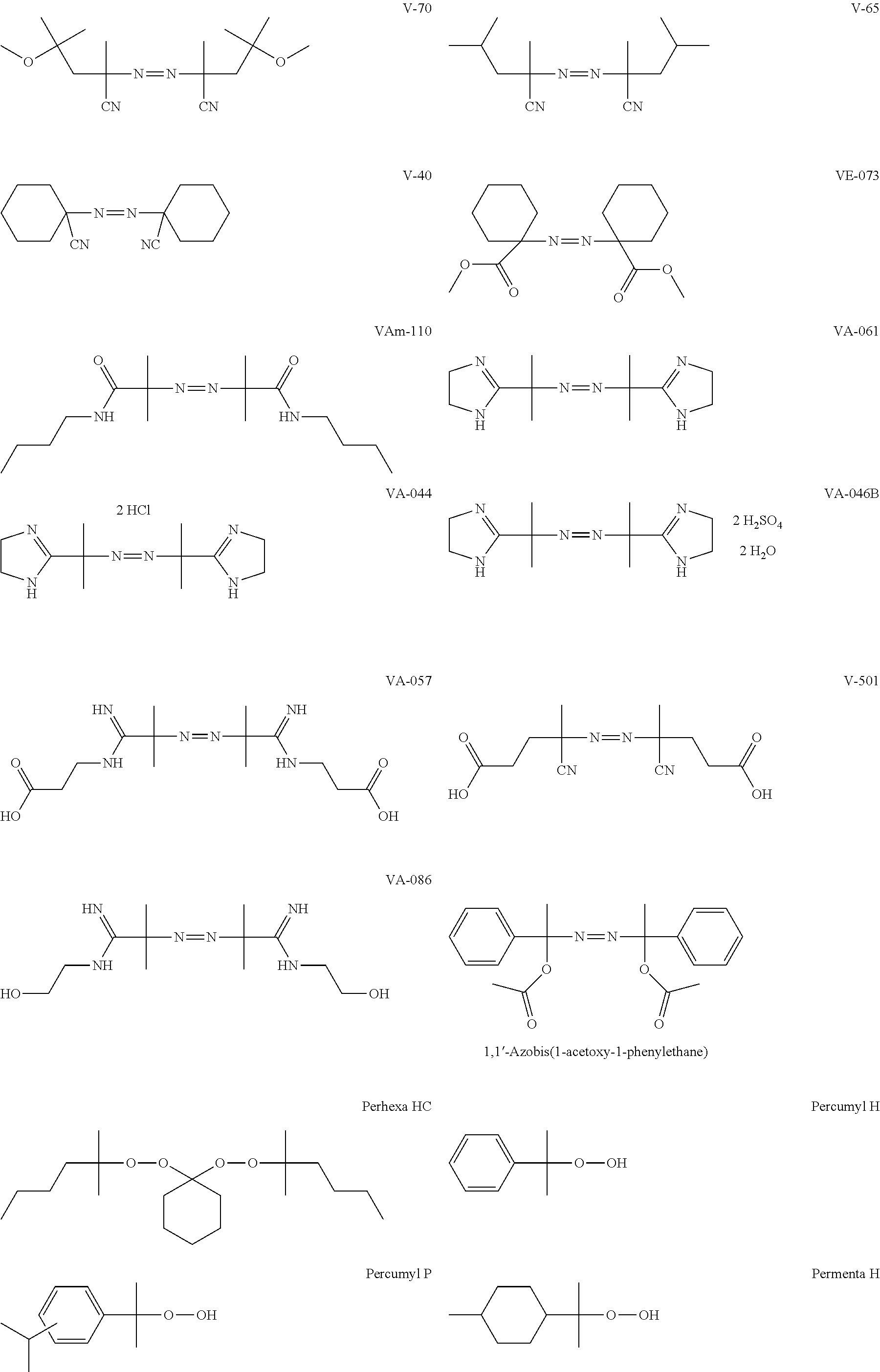

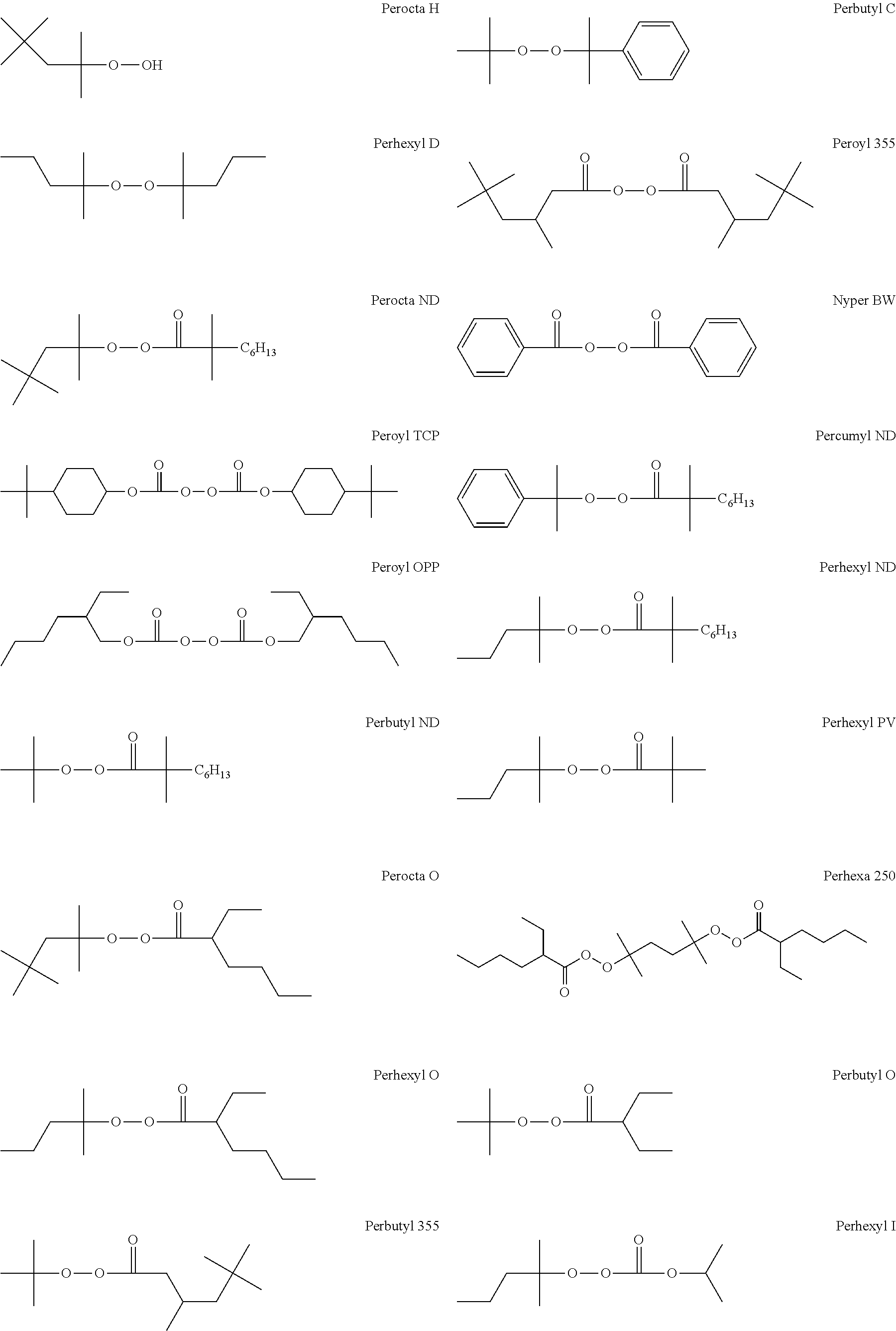

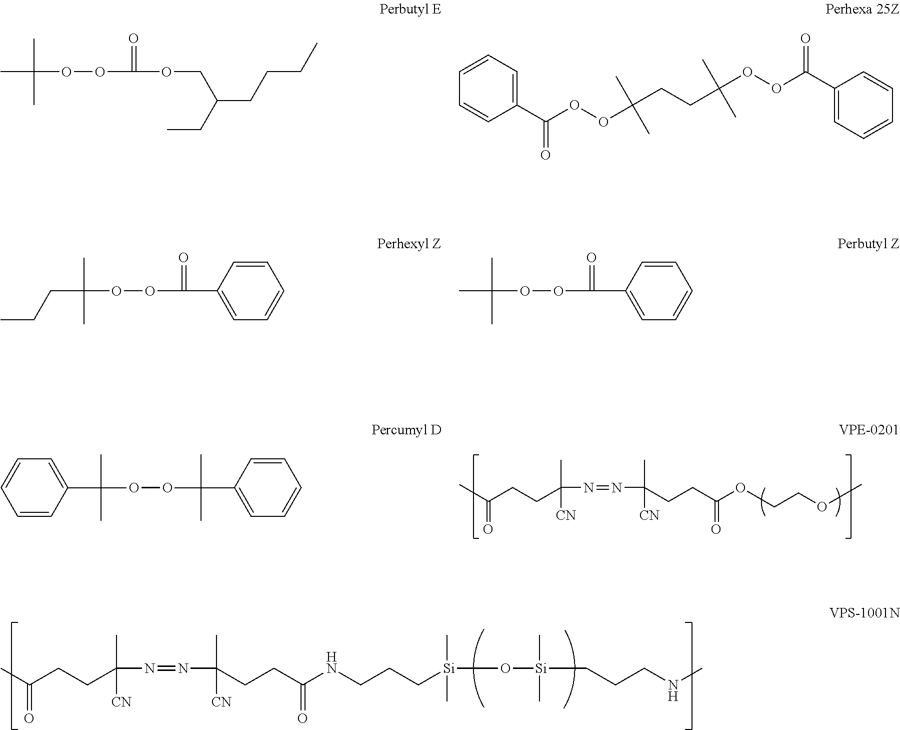

It is preferable that the above-described polymer includes at least one functional group selected from the group (a) of functional groups. This functional group may be included in the main chain or in a side chain but is preferably included in the main chain. The side chain in the functional group may be any component forming the polymer and more preferably is present at a side chain of the above-described repeating unit (K). The specific functional group is included in the side chain such that an interaction with a hydrogen atom, an oxygen atom, or a sulfur atom that is presumed to be present on a surface of the inorganic solid electrolyte, the active material, or the current collector is strengthened, binding properties are further improved, and an increase in interface resistance can be suppressed.

Group (a) of functional groups

a carboxy group, a sulfonate group, a phosphate group, a phosphonate group, an isocyanate group, and a silyl group.

The sulfonate group may be an ester or a salt thereof. In the case of an ester, the number of carbon atoms is preferably 1 to 24, more preferably 1 to 12, and still more preferably 1 to 6.

The phosphate group (phospho group: for example, —OPO(OH)₂) may be an ester or a salt. In the case of an ester, the number of carbon atoms is preferably 1 to 24, more preferably 1 to 12, and still more preferably 1 to 6.

The phosphonate group (for example, —OPO(OH)H) may be an ester or a salt. In the case of an ester, the number of carbon atoms is preferably 1 to 24, more preferably 1 to 12, and still more preferably 1 to 6.

Examples of the silyl group include an alkylsilyl group, an alkoxysilyl group, an arylsilyl group, and an aryloxysilyl group. In particular, an alkoxysilyl group is preferable. The number of carbon atoms in the silyl group is not particularly limited and is preferably 1 to 18, more preferably 1 to 12, and still more preferably 1 to 6.

From the viewpoints of simultaneously improving the binding properties between the solid particles such as the inorganic solid electrolyte, the active material, or a conductive auxiliary agent and the ion conductivity, the content of the binder in the solid electrolyte composition is preferably 0.01 mass % or higher, more preferably 0.05 mass % or higher, and still more preferably 0.1 mass % or higher with respect to 100 mass % of the solid component. From the viewpoint of battery capacity, the upper limit is preferably 20 mass % or lower, more preferably 10 mass % or lower, and still more preferably 5 mass % or lower.

In the solid electrolyte composition according to the embodiment of the present invention, the mass ratio [(the mass of the inorganic solid electrolyte+the mass of the active material)/(the mass of the binder)] of the total mass (total amount) of the inorganic solid electrolyte and the active material to the mass of the binder is preferably in a range of 1,0000 to 1. This ratio is preferably 2000 to 2 and still more preferably 1000 to 10.

The solid electrolyte composition according to the embodiment of the present invention may include one binder alone or two or more binders.

(Synthesis Method of Polymer in Binder)

The polymer in the binder used in the present invention can be synthesized using an ordinary method. For example, the polymer can be obtained by polymerization of a polymerizable compound that includes the structural unit having 6 or more carbon atoms represented by Formula (H-1) or (H-2). In addition, in a case where the polymer is an addition polymerization type polymer, for example, a method of executing addition polymerization of the above-described monomer using a polymerization initiator that can generate the structural unit having 6 or more carbon atoms represented by Formula (H-1) or (H-2) as one radical can be used.

In a polymerization initiator that generates a radical structural unit not having a partial structure corresponding to the structural unit represented by Formula (H-1) is used, a polymer chain (main chain) is formed by addition polymerization of the monomer from the radical structural unit, and the structural unit represented by Formula (H-1) is introduced into a terminal (typically, one terminal) of the main chain. On the other hand, In a polymerization initiator that generates a radical structural unit not having a partial structure corresponding to the structural unit represented by Formula (H-2) is used, a polymer chain (main chain) is formed by addition polymerization of the monomer from each of two radicals in the radical structural unit, and the structural unit represented by Formula (H-2) is introduced into the main chain.

The amount of the polymerization initiator used is not uniquely determined depending on the kind and amount of the radical structural unit generated from the polymerization initiator and the amount thereof introduced into the polymer, but is adjusted such that, for example, the amount of radicals generated is the same as the amount thereof introduced.

<(C) Dispersion Medium>

The solid electrolyte composition according to the embodiment of the present invention includes a dispersion medium.

The dispersion medium is not particularly limited as long as it can disperse the respective components included in the solid electrolyte composition according to the embodiment of the present invention, and it is preferable that a dispersion medium that can disperse the above-described particle binder (the polymer in the binder) in the form of particles is selected. The dispersion medium is not particularly limited, and from the viewpoint of the dispersibility of the particle binder, the C Log P value of the dispersion medium is preferably 1 or higher, more preferably 2 or higher, and still more preferably 2.5 or higher. The upper limit is not particularly limited and is practically 10 or lower.

In the present invention, the C log P value refers to a value obtained by calculating a common logarithm Log P of a partition coefficient P between 1-octanol and water. As a method or software used for calculating the C Log P value, a well-known one can be used. In the present invention, unless specified otherwise, the C Log P value is a value calculated after drawing a structure using ChemBioDraw Ultra (version 13.0, manufactured by PerkinElmer Co., Ltd.).

Examples of the dispersion medium to be used in the present invention include various organic solvents. Examples of the organic solvent include the respective solvents of an alcohol compound, an ether compound, an amide compound, an amine compound, a ketone compound, an aromatic compound, an aliphatic compound, a nitrile compound, and an ester compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of an ether compound include alkylene glycol alkyl ether (for example, ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol monomethyl ether, dipropylene glycol monomethyl ether, tripropylene glycol monomethyl ether, diethylene glycol monobutyl ether, or diethylene glycol monobutyl ether), dialkyl ether (for example, dimethyl ether, diethyl ether, diisopropyl ether, or dibutyl ether), and cyclic ether (for example, tetrahydrofuran or dioxane (including respective isomers of 1,2-, 1,3, and 1,4-)).

Examples of the amide compound include N,N-dimethylformamide, N-methyl-2-pyrrolidone, 2-pyrrolidinone, 1,3-dimethyl-2-imidazolidinone, 2-pyrrolidinone, s-caprolactam, formamide, N-methylformamide, acetamide, N-methylacetamide, N,N-dimethylacetamide, N-methylpropanamide, and hexamethylphosphoric amide.

Examples of the amine compound include triethylamine, diisopropylethylamine, and tributylamine.

Examples of the ketone compound include acetone, methyl ethyl ketone (MEK), methyl isobutyl ketone, cyclohexanone, and diisobutyl ketone (DIBK).

Examples of the aromatic compound include an aromatic hydrocarbon compound such as benzene, toluene, or xylene.

Examples of the aliphatic compound include an aliphatic hydrocarbon compound such as hexane, heptane, octane, or decane.

Examples of the nitrile compound include acetonitrile, propionitrile, and isobutyronitrile.

Examples of the ester compound include a carboxylic acid ester such as ethyl acetate, butyl acetate, propyl acetate, propyl butyrate, isopropyl butyrate, butyl butyrate, isobutyl butyrate, butyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

Examples of a non-aqueous dispersion medium include the aromatic compound and the aliphatic compound described above.

Preferable dispersion mediums will be shown together with C log P values.

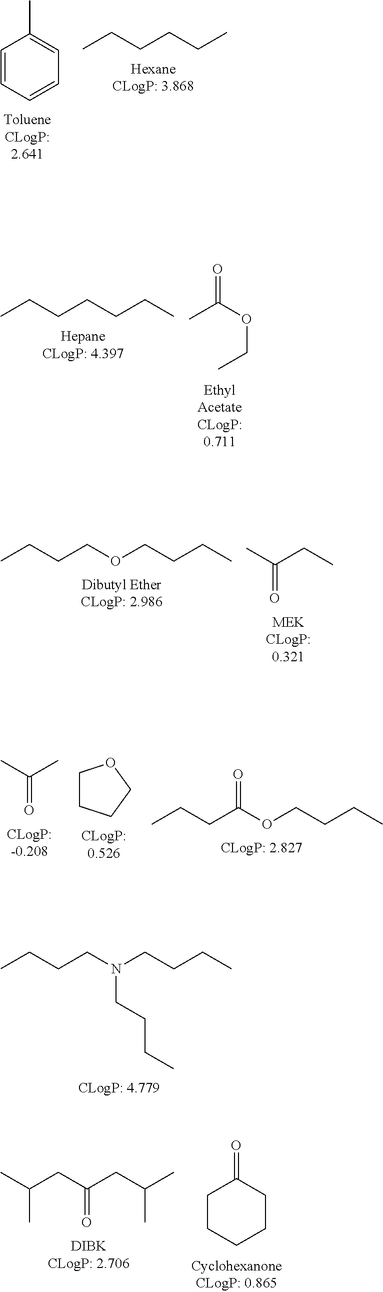

In the present invention, the dispersion medium is preferably a ketone compound, an ester compound, an aromatic compound, or an aliphatic compound and more preferably a dispersion medium including at least one selected from a ketone compound, an ester compound, an aromatic compound, or an aliphatic compound.

The number of non-aqueous dispersion media in the solid electrolyte composition may be one or two or more but is preferably two or more.

The total content of the dispersion medium in the solid electrolyte composition is not particularly limited, but is preferably 10% to 90 mass %, more preferably 15% to 85 mass %, and still preferably 20% to 80 mass %.

<(D) Active Material>

The solid electrolyte composition according to the embodiment of the present invention may also include an active material. This active material is a material capable of intercalating and deintercalating ions of a metal element belonging to Group 1 or Group 2 in the periodic table. Examples of the active material include a positive electrode active material and a negative electrode active material. As the positive electrode active material, a metal oxide (preferably a transition metal oxide) is preferable. As the negative electrode active material, a carbonaceous material, a metal oxide, a silicon material, lithium, a lithium alloy, or a metal capable of forming an alloy with lithium is preferable.

In the present invention, the solid electrolyte composition (electrode layer-forming composition) including the positive electrode active material will also be referred to as “positive electrode composition”. In addition, the solid electrolyte composition (electrode layer-forming composition) including the negative electrode active material will also be referred to as “negative electrode composition”.

(Positive Electrode Active Material)

The positive electrode active material is preferably capable of reversibly intercalating and deintercalating lithium ions. The above-described material is not particularly limited as long as the material has the above-described characteristics and may be transition metal oxides, organic matter, elements capable of being complexed with Li such as sulfur, complexes of sulfur and metal, or the like.

Among these, as the positive electrode active material, transition metal oxides are preferably used, and transition metal oxides having a transition metal element Ma (one or more elements selected from Co, Ni, Fe, Mn, Cu, and V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element Ma. It is more preferable that the transition metal oxide is synthesized by mixing the above components such that a molar ratio Li/M^{a} is 0.3 to 2.2.

Specific examples of the transition metal oxides include transition metal oxides having a layered rock salt structure (MA), transition metal oxides having a spinel-type structure (MB), lithium-containing transition metal phosphate compounds (MC), lithium-containing transition metal halogenated phosphate compounds (MD), and lithium-containing transition metal silicate compounds (ME).

Specific examples of the transition metal oxides having a layered rock salt structure (MA) include LiCoO₂ (lithium cobalt oxide [LCO]), LiNi₂O₂(lithium nickel oxide) LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickel oxide).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphate compounds (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and monoclinic nasicon type vanadium phosphate salt such as Li₃V₂(PO₄)₃ (lithium vanadium phosphate).

Examples of the lithium-containing transition metal halogenated phosphate compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxides having a layered rock salt structure (MA) is preferable, and LCO or NMC is more preferable.

The shape of the positive electrode active material is not particularly limited, but is preferably a particle shape. The average particle size (sphere-equivalent average particle size) of positive electrode active material particles is not particularly limited. For example, the volume average particle diameter can be set to 0.1 to 50 μm. In order to allow the positive electrode active material to have a predetermined particle size, an ordinary pulverizer or classifier may be used. Positive electrode active materials obtained using a calcination method may be used after being washed with water, an acidic aqueous solution, an alkaline aqueous solution, or an organic solvent. The average particle size of the positive electrode active material particles can be measured using the same method as that of the average particle size of the inorganic solid electrolyte.

As the positive electrode active material, one kind may be used alone, or two or more kinds may be used in combination.

In the case of forming a positive electrode active material layer, the mass (mg) of the positive electrode active material per unit area (cm²) of the positive electrode active material layer (weight per unit area) is not particularly limited. The mass can be appropriately determined depending on the designed battery capacity.

The content of the positive electrode active material in the electrode layer-forming composition is not particularly limited, but is preferably 10% to 95 mass %, more preferably 30% to 90 mass %, still more preferably 50% to 85 mass %, and particularly preferably 55% to 80 mass % with respect to a solid content of 100 mass %.

(Negative Electrode Active Material)

The negative electrode active material is preferably capable of reversibly intercalating and deintercalating lithium ions. The material is not particularly limited as long as it has the above-described properties, and examples thereof include a carbonaceous material, a metal oxide, a metal composite oxide, a silicon material, lithium, a lithium alloy, and a metal capable of forming an alloy with lithium. Among these, a carbonaceous material, a metal composite oxide, or lithium is preferably used from the viewpoint of reliability.

The carbonaceous material which is used as the negative electrode active material is a material substantially containing carbon. Examples thereof include petroleum pitch, carbon black such as acetylene black (AB), graphite (natural graphite, artificial graphite such as vapor-grown graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

A metal oxide or a metal composite oxide that can be used as the negative electrode active material is not particularly limited as long as it is an oxide capable of intercalating and deintercalating lithium. The oxides are more preferably amorphous oxides, and preferable examples thereof include chalcogenides which are reaction products between metal elements and elements in Group 16 of the periodic table). “Amorphous” described herein represents an oxide having a broad scattering band with a peak in a range of 200 to 400 in terms of 20 in case of being measured by an X-ray diffraction method using CuKα rays, and the oxide may have a crystal diffraction line.

In a compound group consisting of the amorphous oxides and the chalcogenides, amorphous oxides of metalloid elements and chalcogenides are more preferred, and elements belonging to Groups 13 (IIIB) to 15 (VB) of the periodic table, oxides consisting of one element or a combination of two or more elements of Al, Ga, Si, Sn, Ge, Pb, Sb, and Bi, and chalcogenides are particularly preferable. Specific preferable examples of the amorphous oxides and the chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, SnSiO₃, GeS, SnS, SnS₂, PbS, PbS₂, Sb₂S₃, Sb₂S₅, and SnSiS₃.

It is preferable that the metal (composite) oxide and the chalcogenide include at least one of titanium or lithium as components from the viewpoint of high current density charging-discharging characteristics. Examples of the metal composite oxide (lithium composite metal oxide) including lithium include a composite oxide consisting of lithium oxide and the metal (composite) oxide or the chalcogenide, specifically, Li₂SnO₂.

The negative electrode active material preferably contains a titanium atom. More specifically, Li₄Ti₅O₁₂ (lithium titanium oxide [LTO]) is preferred since the volume fluctuation during the intercalation and deintercalation of lithium ions is small, and thus the high-speed charging-discharging characteristics are excellent, and the deterioration of electrodes is suppressed. Therefore, it becomes possible to improve the service lives of lithium ion secondary batteries.

In the present invention, a negative electrode of a silicon material is also preferably applied. Generally, a Si negative electrode is capable of intercalating a larger number of Li ions than a carbon negative electrode (graphite, acetylene black, or the like). That is, the amount of Li ions intercalated per unit mass increases. Therefore, it is possible to increase the battery capacity. As a result, there is an advantage that the battery driving duration can be extended. Examples of the Silicon material include Si and SiO described above.

The lithium alloy as the negative electrode active material is not particularly limited as long as it is typically used as a negative electrode active material for a secondary battery, and examples thereof include a lithium aluminum alloy.

The metal capable of forming an alloy with lithium is not particularly limited as long as it is typically used as a negative electrode active material for a secondary battery, and examples thereof include metals such as Sn, Si, Al or In.

The shape of the negative electrode active material is not particularly limited, but is preferably a particle shape. The average particle size of the negative electrode active material is preferably 0.1 to 60 μm. In order to obtain a predetermined particle size, an ordinary pulverizer or classifier is used. For example, a mortar, a ball mill, a sand mill, a vibration ball mill, a satellite ball mill, a planetary ball mill, a swirling air flow jet mill, or a sieve is preferably used. During the pulverization, wet pulverization of causing water or an organic solvent such as methanol to coexist with the negative electrode active material can be optionally performed. In order to obtain a desired particle size, it is preferable to perform classification. A classification method is not particularly limited, and a method using, for example, a sieve or an air classifier can be optionally used. The classification can be used using a dry method or a wet method. The average particle size of the negative electrode active material can be measured using the same method as that of the average particle size of the inorganic solid electrolyte.

The chemical formulae of the compounds obtained using a calcination method can be calculated using inductively coupled plasma (ICP) optical emission spectroscopy as a measurement method from the mass difference of powder before and after calcinating as a convenient method.

As the negative electrode active material, one kind may be used alone, or two or more kinds may be used in combination.

In the case of forming a negative electrode active material layer, the mass (mg) of the negative electrode active material per unit area (cm²) in the negative electrode active material layer (weight per unit area) is not particularly limited. The mass can be appropriately determined depending on the designed battery capacity.

The content of the negative electrode active material in the electrode layer-forming composition is not particularly limited, but is preferably 10 to 80 mass % and more preferably 20% to 80 mass % with respect to the solid content of 100 mass %.

In the present invention, in a case where a negative electrode active material layer is formed by charging a battery, ions of a metal belonging to Group 1 or Group 2 in the periodic table produced in the all-solid state secondary battery can be used instead of the negative electrode active material. By binding the ions to electrons and precipitating a metal, a negative electrode active material layer can be formed.

(Coating of Active Material)

The surfaces of the positive electrode active material and the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, a surface treatment may be carried out on the surfaces of electrodes including the positive electrode active material or the negative electrode active material using sulfur, phosphorous, or the like.

Furthermore, the particle surfaces of the positive electrode active material or the negative electrode active material may be treated with an actinic ray or an active gas (plasma or the like) before or after the coating of the surfaces.

<Conductive Auxiliary Agent>

The solid electrolyte composition according to the embodiment of the present invention may also include a conductive auxiliary agent. The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene which are electron-conductive materials and also may be metal powder or a metal fiber of copper, nickel, or the like, and a conductive polymer such as polyaniline, polypyrrole, polythiophene, polyacetylene, or a polyphenylene derivative may also be used.

In the present invention, in a case where the active material and the conductive auxiliary agent are used in combination, among the above-described conductive auxiliary agents, a conductive auxiliary agent that does not intercalate and DE intercalate Li and does not function as an active material during charging and discharging of the battery is classified as the conductive auxiliary agent. Therefore, among the conductive auxiliary agents, a conductive auxiliary agent that can function as the active material in the active material layer during charging and discharging of the battery is classified as an active material not as a conductive auxiliary agent. Whether or not the conductive auxiliary agent functions as the active material during charging and discharging of the battery is not uniquely determined but is determined based on a combination of the conductive auxiliary agent with the active material.

As the conductive auxiliary agent, one kind may be used alone, or two or more kinds may be used in combination.

The content of the conductive auxiliary agent in the electrode layer-forming composition is preferably 0.1% to 5 mass % and more preferably 0.5% to 3 mass % with respect to 100 parts by mass of the solid content.

The shape of the conductive auxiliary agent is not particularly limited, but is preferably a particle shape. The median size D50 of the conductive auxiliary agent is not particularly limited and is, for example, preferably 0.01 to 1 μm and more preferably 0.02 to 0.1 μm.

<Other Additives>

As components other than the respective components described above, the solid electrolyte composition according to the embodiment of the present invention may optionally include a lithium salt, an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant.

[Method of manufacturing Solid Electrolyte Composition]

The solid electrolyte composition according to the embodiment of the present invention can be prepared, preferably, as a slurry by mixing the inorganic solid electrolyte, the binder, and the dispersion medium and optionally other components, for example using various mixers that are typically used.

A mixing method is not particularly limited, and the components may be mixed at once or sequentially. In a case where the binder is in the form of particles, the binder is typically used as a dispersion liquid of the binder, but the present invention is not limited thereto. A mixing environment is not particularly limited, and examples thereof include a dry air environment and an inert gas environment.

[Solid Electrolyte-Containing Sheet]

A solid electrolyte-containing sheet according to the embodiment of the present invention is a sheet-shaped molded body with which a constituent layer of an all-solid state secondary battery can be formed, and includes various aspects depending on uses thereof. Examples of the sheet for an all-solid state secondary battery include a sheet that is preferably used in a solid electrolyte layer (also referred to as a solid electrolyte sheet for an all-solid state secondary battery), and a sheet that is preferably used in an electrode or a laminate of an electrode and a solid electrolyte layer (an electrode sheet for an all-solid state secondary battery).

The solid electrolyte sheet for an all-solid state secondary battery according to the embodiment of the present invention is not particularly limited as long as it is a sheet including a solid electrolyte layer, and may be a sheet in which a solid electrolyte layer is formed on a substrate or may be a sheet that is formed of a solid electrolyte layer without including a substrate. The solid electrolyte sheet for an all-solid state secondary battery may include other layers in addition to the solid electrolyte layer. Examples of the other layers include a protective layer (release sheet), a current collector, and a coating layer.

Examples of the solid electrolyte sheet for an all-solid state secondary battery according to the embodiment of the present invention include a sheet including a layer formed of the solid electrolyte composition according to the embodiment of the present invention, a typical solid electrolyte layer, and optionally a protective layer on a substrate in this order. In the solid electrolyte layer in the solid electrolyte sheet for an all-solid state secondary battery, the solid electrolyte layer is preferably a layer in which solid particles are densely deposited (filled), and the void volume of the layer obtained using a method described in Examples is preferably 0.06 or lower. In a case where the void volume is 0.06 or lower, an effect of reducing the resistance and increasing the energy density can be obtained. The solid electrolyte layer formed of the solid electrolyte composition according to the embodiment of the present invention includes: an inorganic solid electrolyte; and the particle binder that includes the polymer including the structural unit having 6 or more carbon atoms represented by Formula (H-1) or (H-2), in which the above-described high void volume can be achieved. The solid electrolyte layer is the same as a solid electrolyte layer in an all-solid state secondary battery described below and typically does not include an active material. The solid electrolyte sheet for an all-solid state secondary battery can be suitably used as a material forming a solid electrolyte layer for an all-solid state secondary battery.

The substrate is not particularly limited as long as it can support the solid electrolyte layer, and examples thereof include a sheet body (plate-shaped body) formed of materials described below regarding the current collector, an organic material, an inorganic material, or the like. Examples of the organic materials include various polymers, and specific examples thereof include polyethylene terephthalate, polypropylene, polyethylene, and cellulose. Examples of the inorganic materials include glass and ceramic.

An electrode sheet for an all-solid state secondary battery according to the embodiment of the present invention (simply also referred to as “electrode sheet according to the embodiment of the present invention”) is not particularly limited as long as it is an electrode sheet including an active material layer, and may be a sheet in which an active material layer is formed on a substrate (current collector) or may be a sheet that is formed of an active material layer without including a substrate. The electrode sheet is typically a sheet including the current collector and the active material layer, and examples of an aspect thereof include an aspect including the current collector, the active material layer, and the solid electrolyte layer in this order and an aspect including the current collector, the active material layer, the solid electrolyte layer, and the active material layer in this order. The electrode sheet according to the embodiment of the present invention may include the above-described other layers. The thickness of each of the layers forming the electrode sheet according to the embodiment of the present invention is the same as the thickness of each of layers described below regarding the all-solid state secondary battery.

It is preferable that the active material layer in the electrode sheet is formed of the solid electrolyte composition (electrode layer-forming composition) according to the embodiment of the present invention. The electrode sheet can be suitably used as a material forming an active material layer (a negative electrode or positive electrode active material layer) for an all-solid state secondary battery.

[Method of Manufacturing Solid Electrolyte-Containing Sheet]

A method of manufacturing the solid electrolyte-containing sheet is not particularly limited. The solid electrolyte-containing sheet can be manufactured using the solid electrolyte composition according to the embodiment of the present invention. For example, a method of preparing the solid electrolyte composition according to the embodiment of the present invention as described above and forming a film (applying and drying) on the substrate using the obtained solid electrolyte composition to form a solid electrolyte layer (applied and dried layer) on the substrate can be used. As a result, the solid electrolyte-containing sheet including optionally the substrate (current collector) or the current collector and the applied and dried layer can be prepared. Here, the applied and dried layer refers to a layer formed by applying the solid electrolyte composition according to the embodiment of the present invention and drying the dispersion medium (that is, a layer formed using the solid electrolyte composition according to the embodiment of the present invention and made of a composition obtained by removing the dispersion medium from the solid electrolyte composition according to the embodiment of the present invention). In the active material layer and the applied and dried layer, the dispersion medium may remain within a range where the effects of the present invention do not deteriorate, and the residual amount thereof, for example, in each of the layers may be 3 mass % or lower.

In the above-described manufacturing method, it is preferable that the solid electrolyte composition according to the embodiment of the present invention is used as a slurry. The solid electrolyte composition according to the embodiment of the present invention can be converted into a slurry using a well-known method as desired. Each of steps of application, drying, or the like for the solid electrolyte composition according to the embodiment of the present invention will be described below regarding a method of manufacturing an all-solid state secondary battery.

In the method of manufacturing a solid electrolyte-containing sheet according to the embodiment of the present invention, it is also possible to pressurize the applied and dried layer obtained as described above. Pressurization conditions or the like will be described below regarding the method of manufacturing an all-solid state secondary battery.

In addition, in the method of manufacturing a solid electrolyte-containing sheet according to the embodiment of the present invention, it is also possible to peel the substrate, the protective layer (particularly, the release sheet), or the like.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The positive electrode active material layer is formed optionally on a positive electrode current collector to configure a positive electrode. The negative electrode active material layer is formed optionally on a negative electrode current collector to configure a negative electrode.

It is preferable that at least one of the solid electrolyte layer, the positive electrode active material layer, or the negative electrode active material layer in an all-solid state secondary battery is formed of the solid electrolyte composition according to the embodiment of the present invention, which includes an aspect where all the layers are formed of the solid electrolyte composition according to the embodiment of the present invention. The positive electrode active material layer includes an inorganic solid electrolyte, an active material, and a conductive auxiliary agent. In a case where the negative electrode active material layer is not formed of the solid electrolyte composition according to the embodiment of the present invention, as the negative electrode active material layer, for example, a layer including an inorganic solid electrolyte, an active material, and optionally the above-described respective components, a layer (for example, a lithium metal layer) formed of a metal described above as the negative electrode active material, or a layer (sheet) formed of a carbonaceous material described above as the negative electrode active material is adopted. The layer formed of a metal includes, for example, a layer, a metal foil, or a metal deposited film in which powder of a metal such as lithium or an alloy is deposited or molded. The thickness of each of the metal layer and the layer formed of a carbonaceous material is not particularly limited and is, for example, 0.01 to 100 μm. The solid electrolyte layer includes an inorganic solid electrolyte having ion conductivity of a metal belonging to Group 1 or Group 2 in the periodic table; and optionally the above-described components.

(Positive Electrode Active Material Layer, Solid Electrolyte Layer, and Negative Electrode Active Material Layer)

In the all-solid state secondary battery according to the embodiment of the present invention, as described above, a solid electrolyte composition or an active material layer can be formed of the solid electrolyte composition according to the embodiment of the present invention or the above-described solid electrolyte-containing sheet. Unless specified otherwise, it is preferable that the respective components in the solid electrolyte layer and the active material layer to be formed and the contents thereof are the same as those in the solid content of the solid electrolyte composition or the solid electrolyte-containing sheet.

The thicknesses of the negative electrode active material layer, the solid electrolyte layer, and the positive electrode active material layer are not particularly limited respectively. In consideration of the dimension of a general all-solid state secondary battery, each of the thicknesses of the respective layers is preferably 10 to 1,000 μm and more preferably 20 μm or more and less than 500 μm. In the all-solid state secondary battery according to the embodiment of the present invention, the thickness of at least one layer of the positive electrode active material layer, the solid electrolyte layer, or the negative electrode active material layer is still more preferably 50 μm or more and less than 500 μm.

Each of the positive electrode active material layer and the negative electrode active material layer may include the current collector opposite to the solid electrolyte layer.

(Case)

Depending on uses, the all-solid state secondary battery according to the embodiment of the present invention may be used as the all-solid state secondary battery having the above-described structure as it is but is preferably sealed in an appropriate case to be used in the form of a dry cell. The case may be a metallic case or a resin (plastic) case. In a case where a metallic case is used, examples thereof include an aluminum alloy case and a stainless steel case. It is preferable that the metallic case is classified into a positive electrode-side case and a negative electrode-side case and that the positive electrode-side case and the negative electrode-side case are electrically connected to the positive electrode current collector and the negative electrode current collector, respectively. The positive electrode-side case and the negative electrode-side case are preferably integrated by being joined together through a gasket for short-circuit prevention.

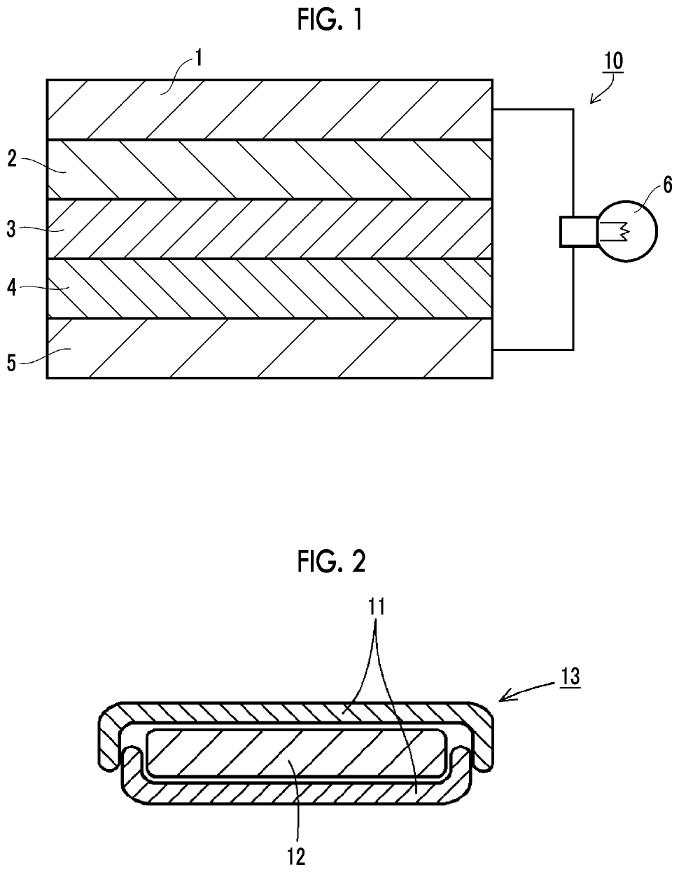

Hereinafter, an all-solid state secondary battery according to a preferred embodiment of the present invention will be described with reference to FIG. 1, but the present invention is not limited thereto.

FIG. 1 is a cross-sectional view schematically illustrating the all-solid state secondary battery (lithium ion secondary battery) according to the preferred embodiment of the present invention. In the case of being seen from the negative electrode side, an all-solid state secondary battery 10 of the present embodiment includes a negative electrode current collector 1, a negative electrode active material layer 2, a solid electrolyte layer 3, a positive electrode active material layer 4, and a positive electrode current collector 5 in this order. The respective layers are in contact with one another and have a laminated structure. In a case in which the above-described structure is employed, during charging, electrons (e) are supplied to the negative electrode side, and lithium ions (Li⁺) are accumulated in the negative electrode side. On the other hand, during discharging, the lithium ions (Li⁺) accumulated in the negative electrode side return to the positive electrode, and electrons are supplied to an operation portion 6. In an example illustrated in the drawing, an electric bulb is employed as the operation portion 6 and is lit by discharging.

The solid electrolyte composition according to the embodiment of the present invention can be preferably used as a material for forming the solid electrolyte layer, the negative electrode active material layer, or the positive electrode active material layer. In addition, the solid electrolyte-containing sheet according to the embodiment of the present invention is suitable as the negative electrode active material layer, the positive electrode active material layer, and the solid electrolyte layer.

In the present specification, the positive electrode active material layer (hereinafter, also referred to as the positive electrode layer) and the negative electrode active material layer (hereinafter, also referred to as the negative electrode layer) will also be collectively referred to as the electrode layer or the active material layer.

In a case where the all-solid state secondary battery having a layer configuration illustrated in FIG. 1 is put into a 2032-type coin case, the all-solid state secondary battery will be referred to as “laminate for an all-solid state secondary battery”, and a battery prepared by putting this laminate for an all-solid state secondary battery into a 2032-type coin case will be referred to as “all-solid state secondary battery”, thereby referring to both batteries distinctively in some cases.

(Positive Electrode Active Material Layer, Solid Electrolyte Layer, and Negative Electrode Active Material Layer)

In the all-solid state secondary battery 10, any one of the solid electrolyte layer or the active material layer is formed using the solid electrolyte composition according to the embodiment of the present invention or the above-described solid electrolyte-containing sheet. In a preferable aspect, all the layers are formed using the solid electrolyte composition according to the embodiment of the present invention or the above-described solid electrolyte-containing sheet. In another preferable aspect, the solid electrolyte layer and the positive electrode active material layer are formed using the solid electrolyte composition according to the embodiment of the present invention or the above-described solid electrolyte-containing sheet. In addition to the method of forming the negative electrode active material layer using the solid electrolyte composition according to the embodiment of the present invention or the above-described electrode sheet, the negative electrode active material layer can also be formed by using a layer formed of a metal, a layer formed of a carbonaceous material, or the like as the negative electrode active material and further precipitating a metal on a negative electrode current collector or the like during charging.

The respective components included in the positive electrode active material layer 4, the solid electrolyte layer 3, and the negative electrode active material layer 2 may be the same as or different from each other.

The positive electrode current collector 5 and the negative electrode current collector 1 are preferably an electron conductor.

In the present invention, either or both of the positive electrode current collector and the negative electrode current collector will also be simply referred to as the current collector.

As a material for forming the positive electrode current collector, not only aluminum, an aluminum alloy, stainless steel, nickel, or titanium but also a material (a material on which a thin film is formed) obtained by treating the surface of aluminum or stainless steel with carbon, nickel, titanium, or silver is preferable. Among these, aluminum or an aluminum alloy is more preferable.

As a material for forming the negative electrode current collector, not only aluminum, copper, a copper alloy, stainless steel, nickel, or titanium but also a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the current collector, typically, current collectors having a film sheet-like shape are used, but it is also possible to use net-shaped collectors, punched collectors, compacts of lath bodies, porous bodies, foaming bodies, or fiber groups, and the like.

The thickness of the current collector is not particularly limited, but is preferably 1 to 500 μm. In addition, it is also preferable that the surface of the current collector is made to be uneven through a surface treatment.

In the present invention, a functional layer, a member, or the like may be appropriately interposed or disposed between the respective layers of the negative electrode current collector, the negative electrode active material layer, the solid electrolyte layer, the positive electrode active material layer, and the positive electrode current collector or on the outside thereof. In addition, each of the layers may have a single-layer structure or a multi-layer structure.

[Method of Manufacturing All-Solid State Secondary Battery]

The all-solid state secondary battery according to the embodiment of the present invention is not particularly limited an can be manufacturing method through (including) a method of manufacturing the solid electrolyte composition according to the embodiment of the present invention. Focusing on raw materials to be used, the all-solid state secondary battery can be manufactured using the solid electrolyte composition according to the embodiment of the present invention. Specifically, the all-solid state secondary battery can be manufactured by preparing the solid electrolyte composition according to the embodiment of the present invention as described above and forming a solid electrolyte layer and/or an active material layer of the all-solid state secondary battery using the obtained solid electrolyte composition or the like. As a result, an all-solid state secondary battery having high battery capacity can be manufactured. A method of preparing the solid electrolyte composition according to the embodiment of the present invention is as described above, and the description thereof will not be repeated.

The all-solid state secondary battery according to the embodiment of the present invention can be manufactured through a method including (through) a step of applying (forming a film of) the solid electrolyte composition according to the embodiment of the present invention to the substrate (for example, the metal foil as the current collector) to form a coating film.

For example, the solid electrolyte composition (electrode layer-forming composition) according to the embodiment of the present invention as the positive electrode composition is applied to a metal foil which is a positive electrode current collector so as to form a positive electrode active material layer. As a result, a positive electrode sheet for an all-solid state secondary battery is prepared. Next, the solid electrolyte composition according to the embodiment of the present invention for forming a solid electrolyte layer is applied to the positive electrode active material layer so as to form the solid electrolyte layer. Furthermore, the solid electrolyte composition (electrode layer-forming composition) according to the embodiment of the present invention as the negative electrode composition is applied to the solid electrolyte layer so as to form a negative electrode active material layer. By laminating the negative electrode current collector (metal foil) on the negative electrode active material layer, an all-solid state secondary battery having a structure in which the solid electrolyte layer is sandwiched between the positive electrode active material layer and the negative electrode active material layer can be obtained. Optionally by sealing the laminate in a case, a desired all-solid state secondary battery can be obtained.

In addition, an all-solid state secondary battery can also be manufactured by forming the negative electrode active material layer, the solid electrolyte layer, and the positive electrode active material layer on the negative electrode current collector in order reverse to that of the method of forming the respective layers and laminating the positive electrode current collector thereon.

As another method, for example, the following method can be used. That is, the positive electrode sheet for an all-solid state secondary battery is prepared as described above. In addition, the solid electrolyte composition according to the embodiment of the present invention is applied as a negative electrode composition to a metal foil which is a negative electrode current collector so as to form a negative electrode active material layer. As a result, a negative electrode sheet for an all-solid state secondary battery is prepared. Next, the solid electrolyte layer is formed on the active material layer in any one of the sheets by applying solid electrolyte composition according to the embodiment of the present invention thereto as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. This way, an all-solid state secondary battery can be manufactured.

As still another method, for example, the following method can be used. That is, the positive electrode sheet for an all-solid state secondary battery and the negative electrode sheet for an all-solid state secondary battery are prepared as described above. In addition, separately from the electrode sheets, the solid electrolyte composition is applied to a substrate to prepare a solid electrolyte sheet for an all-solid state secondary battery including the solid electrolyte layer. Furthermore, the positive electrode sheet for an all-solid state secondary battery and the negative electrode sheet for an all-solid state secondary battery are laminated such that the solid electrolyte layer removed from the substrate is sandwiched therebetween. This way, an all-solid state secondary battery can be manufactured.

The respective manufacturing methods are the methods of forming the solid electrolyte layer, the negative electrode active material layer, and the positive electrode active material layer using the solid electrolyte composition according to the embodiment of the present invention. However, in the method of manufacturing the all-solid state secondary battery according to the embodiment of the present invention, at least one of the solid electrolyte layer, the negative electrode active material layer, or the positive electrode active material layer is formed using the solid electrolyte composition according to the embodiment of the present invention. In a case where the solid electrolyte layer is formed using a composition other than the solid electrolyte composition according to the embodiment of the present invention and in a case where the negative electrode active material layer is formed using a solid electrolyte composition that is typically used, examples of a material of the composition a well-known negative electrode active material, a metal (metal layer) as a negative electrode active material, and a carbonaceous material (carbonaceous material layer) as a negative electrode active material. In addition, the negative electrode active material layer can also be formed by binding ions of a metal belonging to Group 1 or Group 2 in the periodic table that are accumulated on a negative electrode current collector during initialization described below or during charging for use without forming the negative electrode active material layer during the manufacturing of the all-solid state secondary battery to electrons and precipitating the ions on a negative electrode current collector or the like as a metal.

<Formation of Respective layers (Film Formation)>

The method for applying the composition used for manufacturing the all-solid state secondary battery is not particularly limited and can be appropriately selected. Examples thereof include coating (preferably wet-type coating), spray coating, spin coating, dip coating, slit coating, stripe coating, and bar coating.

In this case, the composition may be dried after being applied each time or may be dried after being applied multiple times. The drying temperature is not particularly limited. The lower limit is preferably 30° C. or higher, more preferably 60° C. or higher, and still more preferably 80° C. or higher. The upper limit is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (applied and dried layer). In addition, the temperature is not excessively increased, and the respective members of the all-solid state secondary battery are not impaired, which is preferable. Therefore, in the all-solid state secondary battery, excellent total performance can be exhibited, and excellent binding properties can be obtained.

As described above, in a case where the solid electrolyte composition according to the embodiment of the present invention is applied and dried, a dense applied and dried layer having a small void volume in which solid particles are strongly bound and the interface resistance between the solid particles is low can be optionally formed.

After the application of the composition or after the preparation of the all-solid state secondary battery, the respective layers or the all-solid state secondary battery is preferably pressurized. In addition, the respective layers are also preferably pressurized in a state where they are laminated. Examples of the pressurization method include a method using a hydraulic cylinder pressing machine. The pressure is not particularly limited, but is, generally, preferably in a range of 50 to 1,500 MPa.

In addition, the applied composition may be heated while being pressurized. The heating temperature is not particularly limited, but is generally in a range of 30° C. to 300° C. The respective layers or the all-solid state secondary battery can also be pressed at a temperature higher than the glass transition temperature of the inorganic solid electrolyte.

The pressurization may be carried out in a state in which a coating solvent or the dispersion medium has been dried in advance or in a state in which a coating solvent or the dispersion medium remains.

The respective compositions may be applied at the same time, and the application, the drying, and the pressing may be carried out simultaneously and/or sequentially. The respective compositions may be applied to separate substrates and then laminated by transfer.

The atmosphere during the pressurization is not particularly limited and may be any one of in the atmosphere, under the dried air (the dew point: −20° C. or lower), in an inert gas (for example, in an argon gas, in a helium gas, or in a nitrogen gas), and the like. Since the inorganic solid electrolyte reacts with moisture, it is preferable that the atmosphere during pressurization is dry air or an inert gas.

The pressing time may be a short time (for example, within several hours) at a high pressure or a long time (one day or longer) under the application of an intermediate pressure. In the case of members other than the solid electrolyte-containing sheet, for example, the all-solid state secondary battery, it is also possible to use a restraining device (screw fastening pressure or the like) of the all-solid state secondary battery in order to continuously apply an intermediate pressure.

The pressing pressure may be uniform or variable with respect to a pressed portion such as a sheet surface.

The pressing pressure may be variable depending on the area or the thickness of the pressed portion. In addition, the pressure may also be variable stepwise for the same portion.

A pressing surface may be smooth or roughened.

<Initialization>

The all-solid state secondary battery manufactured as described above is preferably initialized after the manufacturing or before the use. The initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is ordinarily used.

[Usages of All-Solid State Secondary Battery]

The all-solid state secondary battery according to the embodiment of the present invention can be applied to a variety of usages. Application aspects are not particularly limited, and, in the case of being mounted in electronic apparatuses, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, and memory cards. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with solar batteries.

### EXAMPLES

Hereinafter, the present invention will be described in more detail on the basis of examples. Meanwhile, the present invention is not interpreted to be limited thereto.

### Synthesis Example of Polymer in Binder (B)

### Synthesis of Polymer B-1 (Preparation of Polymer B-1 Dispersion Liquid)

200 parts by mass of butyl butyrate was added to a 1 L three-neck flask equipped with a reflux cooling pipe and a gas introduction coke, nitrogen gas was introduced at a flow rate of 200 mL/min for 10 minutes, and the solution was heated to 80° C. A liquid (a solution in which 136 parts by mass of hydroxyethyl acrylate (M1 in Table 1 below, manufactured by Wako Pure Chemical Industries, Ltd.), 60 parts by mass (solid content) of a macromonomer MM-1 (MM in Table 1 below), and 4.0 parts by mass of a polymerization initiator V-70 (trade name, manufactured by Wako Pure Chemical Industries, Ltd.) were mixed with each other) prepared in a separate container was added dropwise to the solution for 2 hours and was stirred at 80° C. for 2 hours. Further, the solution was heated to a temperature of 90° C. and stirred for 2 hours. As a result, a dispersion liquid of a polymer B-1 (particles) having the following structure was obtained.

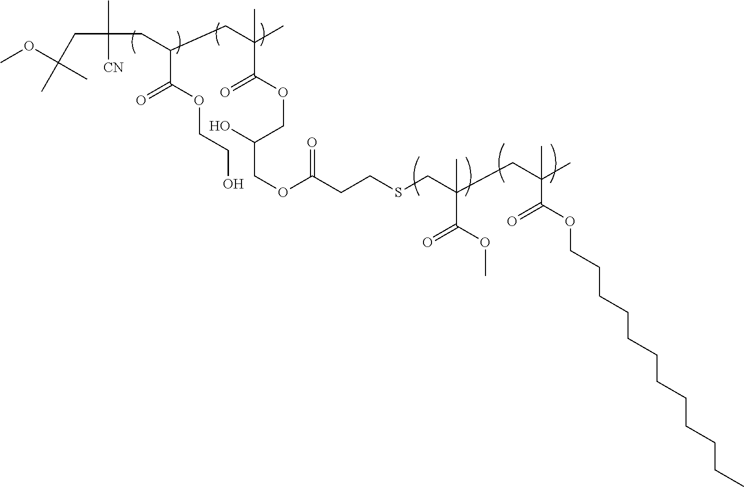

(Synthesis of Macromonomer MM-1)

190 parts by mass of toluene was added to a 1 L three-neck flask equipped with a reflux cooling pipe and a gas introduction coke, nitrogen gas was introduced at a flow rate of 200 mL/min for 10 minutes, and the solution was heated to 80° C. A liquid (the following formula a) prepared in a separate container was added dropwise to the solution for 2 hours and was stirred at 80° C. for 2 hours. Next, 0.2 parts by mass of V-601 (manufactured by Wako Pure Chemical Industries, Ltd.) was added, and the solution was stirred at 95° C. for 2 hours. 0.025 parts by mass of 2,2,6,6-tetramethylpiperidine-1-oxyl (manufactured by Tokyo Chemical Industry Co., Ltd.), 13 parts by mass of glycidyl methacrylate (manufactured by Wako Pure Chemical Industries, Ltd.), and 2.5 parts by mass of tetrabutylammonium bromide (manufactured by Tokyo Chemical Industry Co., Ltd.) were added to the solution held at 95° C. after stirring, and the solution was stirred at 120° C. for 3 hours. The obtained mixture was cooled to a room temperature and was added to methanol to be precipitated. Precipitates were separated by filtration and were washed with methanol two times. 300 parts by mass of heptane was added to the precipitates to dissolve the precipitates. By removing a part of the obtained solution by distillation under reduced pressure, a solution of a macromonomer MM-1 was obtained. The concentration of solid contents was 43.4%, the SP value was 9.1, and the mass average molecular weight was 18,000.

(Formula α)

| | |
|---|---|
| Dodecyl methacrylate (manufactured by | 150 parts by mass |
| Wako Pure Chemical Industries, Ltd.) | |
| Methyl methacrylate (manufactured by | 59 parts by mass |
| Wako Pure Chemical Industries, Ltd.) | |
| 3-mercaptopropionic acid (manufactured by | 2 parts by mass |
| Tokyo Chemical Industry Co., Ltd.) | |
| V-601 (manufactured by Wako Pure | |
| Chemical Industries, Ltd.) | 1.9 parts by mass |

The structure of the obtained macromonomer MM-1 is shown below.

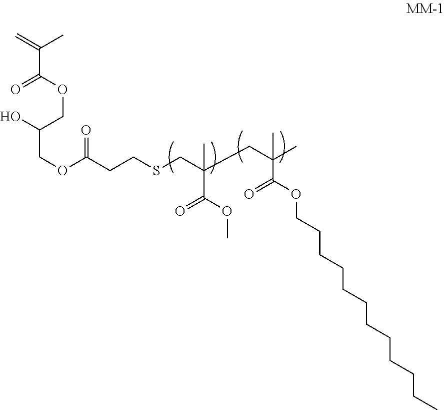

<Synthesis of Polymers B-2 to B-8 and BC-1 (Preparation of Dispersion Liquids or Solutions of Polymers B-2 to B-8 and BC-1)>

Polymers B-2 to B-8 and BC-1 were synthesized (prepared) using the same method as that of the above-described polymer B-1, except that compounds for deriving or forming the components shown in Table 1 below were used as the compounds for deriving the respective components in amounts used for obtaining the contents shown in Table 1.

<Synthesis of Polymer B-9 (Preparation of Polymer B-9 Dispersion Liquid)>

200 parts by mass of butyl butyrate and 30 parts by mass of VPS-1001N (trade name, manufactured by Wako Pure Chemical Industries, Ltd.) was added to a 1 L three-neck flask equipped with a reflux cooling pipe and a gas introduction coke, nitrogen gas was introduced at a flow rate of 200 mL/min for 10 minutes, and the solution was heated to 80° C. A liquid (a solution in which 90 parts by mass of hydroxyethyl acrylate (M1 in Table 1 below, manufactured by Wako Pure Chemical Industries, Ltd.), 50 parts by mass of acrylic acid (manufactured by Wako Pure Chemical Industries, Ltd.), and 30 parts by mass (solid content) of a macromonomer MM-1 (MM in Table 1 below) were mixed with each other) prepared in a separate container was added dropwise to the solution for 2 hours and was stirred at 80° C. for 2 hours. Further, the solution was heated to a temperature of 90° C. and stirred for 2 hours. As a result, a dispersion liquid of a polymer B-9 (particles) was obtained.

<Synthesis of Polymers B-10 and B-11 (Preparation of Polymers B-10 and B-11)>

Polymers B-10 to B-11 were synthesized (prepared) using the same method as that of the above-described polymer B-9, except that compounds for deriving or forming the components shown in Table 1 below were used as the compounds for deriving the respective components in amounts used for obtaining the contents shown in Table 1.

<Synthesis of Binder Particles BC-2 (Preparation of Binder Particle BC-2 Dispersion Liquid)>

200 parts by mass of methyl methacrylate (manufactured by Wako Pure Chemical Industries, Ltd.), 152 parts by mass of styrene (manufactured by Wako Pure Chemical Industries, Ltd.), 8 parts by mass of divinylbenzene (manufactured by Wako Pure Chemical Industries, Ltd.), 10 parts by mass of sodium dodecylbenzene sulfonate (manufactured by W ako Pure Chemical Industries, Ltd.), 400 parts by mass of ion exchange water, and 8 parts by mass of azobisbutyronitrile (AIBN, manufactured by Wako Pure Chemical Industries, Ltd.) as a polymerization initiator were charged to a 5 L three-neck flask equipped with a reflux cooling pipe and a gas introduction coke. Next, the solution was sufficiently stirred, was heated to 80° C., and was polymerized for 4 hours. 424 parts by mass of nonylphenoxypolyethylene glycol acrylate (manufactured by Hitachi Chemical Co., Ltd. functional acrylate, “FANCRYL FA-314A” (trade name)), 100 parts by mass of styrene (manufactured by Wako Pure Chemical Industries, Ltd.), 800 parts by mass of ion exchange water, and 8 parts by mass of azobisbutyronitrile (AIBN, manufactured by Wako Pure Chemical Industries, Ltd.) as a polymerization initiator were added. Next, the solution was sufficiently mixed and polymerized at 80° C. for 4 hours. As a result, a latex was obtained. The obtained latex was poured into another container, and 15,000 parts by mass of butyl butyrate was added thereto. The solution was sufficiently dispersed, and moisture was removed by drying under reduced pressure. As a result, a polymer BC-2 was obtained.

TABLE 1

| | MI | | M2 | | M3 | | MM | | Initiator | |
|---|---|---|---|---|---|---|---|---|---|---|
| No. | | Mass % | | Mass % | | Mass % | | Mass % | | Mass % |
| B-1 | HEA | 68 | | | | | MM-1 | 30 | V-70 | 2 |
| B-2 | HEA | 68 | | | | | MM-1 | 30 | Perhexyl | 2 |
| | | | | | | | | | D | |
| B-3 | HEA | 63 | AA | 5 | | | MM-1 | 30 | Perhexyl | 2 |
| | | | | | | | | | D | |
| B-4 | HEA | 67 | | | | | MM-1 | 28 | V-70 | 5 |
| B-5 | HEA | 45 | AA | 22 | | | MM-1 | 28 | V-70 | 5 |
| B-6 | BA | 67 | | | | | MM-1 | 28 | V-70 | 5 |
| B-7 | HEA | 45 | AA | 25 | | | MM-1 | 21 | V-70 | 9 |
| B-8 | HEA | 45 | AA | 25 | | | MM-1 | 15 | V-70 | 15 |
| B-9 | HEA | 45 | AA | 25 | | | MM-1 | 15 | VPS- | 15 |
| | | | | | | | | | 1001N | |
| B-10 | HEA | 60 | AA | 25 | | | | | VPS- | 15 |
| | | | | | | | | | 1001N | |
| B-11 | HEA | 60 | AEHS | 25 | | | | | VPS- | 15 |
| | | | | | | | | | 100IN | |
| BC-1 | BA | 98 | | | | | | | V-601 | 2 |
| BC-2 | MMA | 25 | St | 19 | DVB | 1 | NP- | 53 | AIBN | 2 |
| | | | | | | | PEGAA | | | |
| | | | | | | Dispersion Medium | | | | |
| | | | | | Content | | CLogP | | | Particle Size |
| | | | No. | Formula | Mass % | Kind | Value | Shape | Mw | (nm) |
| | | | B-1 | Formula | 1 | Butyl | 2.8 | Particle | 78000 | 145 |
| | | | | (H-3) | | Butyrate | | | | |
| | | | B-2 | Formula | 1 | Butyl | 2.8 | Particle | 58000 | 156 |
| | | | | (H-1) | | Butyrate | | | | |
| | | | B-3 | Formula | 1 | Butyl | 2.8 | Particle | 72000 | 148 |
| | | | | (H-1) | | Butyrate | | | | |
| | | | B-4 | Formula | 2 | Butyl | 2.8 | Particle | 68000 | 125 |
| | | | | (H-3) | | Butyrate | | | | |
| | | | B-5 | Formula | 2 | Butyl | 2.8 | Particle | 82000 | 123 |
| | | | | (H-3) | | Butyrate | | | | |
| | | | B-6 | Formula | 2 | Butyl | 2.8 | Solution | 85000 | Not |
| | | | | (H-3) | | Butyrate | | | | Measurable |
| | | | B-7 | Formula | 4 | Butyl | 2.8 | Particle | 78000 | 102 |
| | | | | (H-3) | | Butyrate | | | | |
| | | | B-8 | Formula | 6 | Butyl | 2.8 | Particle | 76000 | 93 |
| | | | | (H-3) | | Butyrate | | | | |
| | | | B-9 | Formula | 7 | Butyl | 2.8 | Particle | 103000 | 98 |
| | | | | (H-5) | | Butyrate | | | | |
| | | | B-10 | Formula | 7 | Butyl | 2.8 | Particle | 105000 | 123 |
| | | | | (H-5) | | Butyrate | | | | |
| | | | B-11 | Formula | 7 | Butyl | 2.8 | Particle | 112000 | 135 |
| | | | | (H-5) | | Butyrate | | | | |
| | | | BC-1 | 1* | 1 | Butyl | 2.8 | Solution | 75000 | Not |
| | | | | | | Butyrate | | | | Measurable |
| | | | BC-2 | 2* | 1 | Butyl | 2.8 | Particle | 56000 | 123 |
| | | | | | | Butyrate | | | | |

HEA: hydroxyethyl acrylate (manufactured by Wako Pure Chemical Industries, Ltd.)
AA: acrylic acid (manufactured by Wako Pure Chemical Industries, Ltd.)
BA: butyl acrylate (manufactured by Wako Pure Chemical Industries, Ltd.)
AEHS: mono(2-acryloyloxyethyl) succinate (manufactured by Tokyo Chemical Industry Co., Ltd.)
MMA: methyl methacrylate (manufactured by Wako Pure Chemical Industries, Ltd.)
St: styrene (manufactured by Wako Pure Chemical Industries, Ltd.)
NP-PEGAA: nonylphenoxypolyethylene glycol acrylate (trade name: FA-314A, manufactured by Hitachi Chemical Co., Ltd.)
V-70: trade name manufactured by Wako Pure Chemical Industries, Ltd. (2,2′-Azobis(4-methoxy-2,4-dimethylvaleronitrile))
PERHEXA HC: trade name, manufactured by NOF Corporation, 1,1-Di(t-hexylperoxy)cyclohexane (trade name: PERHEXA HC, manufactured by NOF Corporation)
VPS-1001N: trade name (manufactured by Wako Pure Chemical Industries, Ltd.)
V-601: Dimethyl 2,2′azobis(2-methylpropionate) (manufactured by Wako Pure Chemical Industries, Ltd.)
AIBN: 2,2′-Azobis(isobutyronitrile) (manufactured by Wako Pure Chemical Industries, Ltd.)
MM-1: a macromonomer synthesized using the above-described synthesis method
DVB: divinylbenzene
“Formula”: any one of Formulae (H-1) to (H-5) to which the structural unit in the polymer belongs.
“Content”: the content of the structural unit represented by any one of Formulae (H-1) to (H-5) with respect to all the component in the polymer. A method of measuring this content is as follows.

The obtained polymer solution was heated in heavy DMSO at 60° C. and was measured by ¹H-NMR (manufactured by BRUKER Corporation, AVANCE III HD NanoBay 400 MHz, cumulative number: 32). An integrated value of a peak derived from the dispersion medium used and a peak derived from the initiator was calculated, mass % of the structural unit derived from the initiator with respect to the dispersion medium was calculated, and the content was calculated from the following formula using a separately calculated concentration of solid contents. By rounding off the decimal point of the value, the content was obtained.

Content=Mass % of Structural Unit derived from Initiator to Dispersion Medium×(100−Concentration of Solid Contents)/Concentration of Solid Contents (%)

<Method of Calculating Solid Content>

0.5 g of the polymer solution was weighted in a aluminum cup, was dried using a vacuum drying machine at 130° C. for 4 hours. The amount of solid contents after drying was measured, and the concentration of solid contents was calculated from the following expression. As the measured value, an average value of three measured values was adopted.

Concentration of Solid Contents (%)=Amount (g) of Solid Contents after Drying/Amount (g) of Polymer Solution×100

Mw: Mass average molecular weight

1*, 2*: the following structural unit, “*” in the formula represents the binding site.

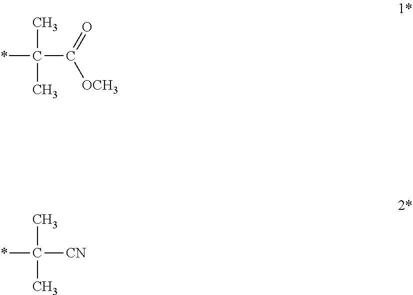

<Synthesis of Sulfide-Based Inorganic Solid Electrolyte>

As a sulfide-based inorganic solid electrolyte, Li—P—S-based glass was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a glove box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed, and put into an mortar. The molar ratio between Li₂S and P₂S₅ (Li₂S:P₂S) was set to 75:25 in terms of molar ratio. The components were mixed using an agate mortar for 5 minutes.

66 g of zirconia beads having a diameter of 5 mm were put into a 45 mL zirconia container (manufactured by Fritsch Japan Co., Ltd.), the full amount of the mixture was put thereinto, and the container was sealed in an argon atmosphere. The container was set in a planetary ball mill P-7 (trade name, manufactured by Fritsch Japan Co., Ltd.), mechanical milling was carried out at 25° C. and a rotation speed of 510 rpm for 20 hours, and a yellow powder (6.20 g) of a sulfide-based inorganic solid electrolyte (Li—P—S-based glass, LPS) was obtained. The volume average particle size was 15 μm.

### Example 1

A solid electrolyte composition and a solid electrolyte-containing sheet were manufactured, and the following properties of the solid electrolyte composition and the solid electrolyte-containing sheet were evaluated. The results are shown in Table 2.

<Preparation of Solid Electrolyte Composition>

180 zirconia beads having a diameter of 5 mm were put into a 45 mL zirconia container (manufactured by Fritsch Japan Co., Ltd.), and 4.85 g of LPS, the dispersion liquid or the solution (0.15 g in terms of solid contents) of the polymer shown in Table 2 below, and 16.0 g of the dispersion medium shown in Table 2 below were put thereinto. Next, the container was set in a planetary ball mill P-7 (trade name, manufactured by Fritsch Japan Co., Ltd.) and the components were continuously mixed for 10 minutes at a temperature of 25° C. and a rotation speed of 150 rpm. As a result, solid electrolyte compositions C-1 to C-12 and BC-1 and BC-2 were prepared.

<Preparation of Solid Electrolyte-Containing Sheet>

Each of the solid electrolyte compositions obtained as described above was applied to an aluminum foil having a thickness of 20 μm using an applicator (trade name: a Baker type applicator SA-201, manufactured by Tester Sangyo Co., Ltd.), and was heated at 80° C. for 2 hours to dry the solid electrolyte composition. Next, using a heat press machine, the solid electrolyte composition that was dried at a temperature of 120° C. and a pressure of 600 MPA for 10 seconds was heated and pressurized. As a result, solid electrolyte-containing sheets S-1 to S-12, BS-1, and BS-2 were prepared. The thickness of the solid electrolyte layer was 50 μm.

<Evaluation 1: Evaluation of Dispersibility>

The solid electrolyte composition was added to a glass test tube having a diameter of 10 mm and a height of 15 cm up to a height of 10 cm and was left to stand at 25° C. for 2 hours. Next, the height of the separated supernatant liquid was observed and measured by visual inspection. A ratio (height of supernatant liquid/height of total amount) of the height of the supernatant liquid to the height (10 cm) of the total amount of the solid electrolyte composition was obtained. The dispersibility (dispersion stability) of the solid electrolyte composition was evaluated based on one of the following evaluation ranks in which this ratio was included. During the calculation of the above-described ratio, the total amount refers to the total amount (10 cm) of the solid electrolyte composition put into the glass test tube, and the height of the supernatant liquid refers to the amount (cm) of the supernatant liquid produced (by solid-liquid separation) by precipitation of the solid components of the solid electrolyte composition.

In this test, as the above-described ratio decreases, the dispersibility is higher, and an evaluation rank of “5” or higher is an acceptable level.

—Evaluation Standards—

8: Height of Supernatant Liquid/Height of Total Amount<0.1

7: 0.1≤Height of Supernatant Liquid/Height of Total Amount<0.2

6: 0.2≤Height of Supernatant Liquid/Height of Total Amount<0.3

5: 0.3≤Height of Supernatant Liquid/Height of Total Amount<0.4

4: 0.4≤Height of Supernatant Liquid/Height of Total Amount<0.5

3: 0.5≤Height of Supernatant Liquid/Height of Total Amount<0.7

2: 0.7≤Height of Supernatant Liquid/Height of Total Amount<0.9

1: 0.9≤Height of Supernatant Liquid/Height of Total Amount

<Evaluation 2: Evaluation of Binding Properties>

Each of the solid electrolyte-containing sheets was wound around rods having different diameters, whether or not chipping and cracking of the solid electrolyte layer and the peeling of the solid electrolyte layer from the aluminum foil (current collector) occurred was checked, the minimum diameter of the rod around which the solid electrolyte-containing sheet was wound without abnormality was checked, and the evaluation was performed based on the following evaluation standards.

In the present invention, as the minimum diameter of the rod decreases, the binding properties are stronger, and an evaluation rank of “5” or higher is an acceptable level.

—Evaluation Standards—

8: the minimum diameter of the rod around which the solid electrolyte-containing sheet was wound without abnormality<2 mm

7: 2 mm≤the minimum diameter of the rod around which the solid electrolyte-containing sheet was wound without abnormality<4 mn

6: 4 mm≤the minimum diameter of the rod around which the solid electrolyte-containing sheet was wound without abnormality<6 mm

5: 6 mm≤the minimum diameter of the rod around which the solid electrolyte-containing sheet was wound without abnormality<10 mm

4: 10 mm≤the minimum diameter of the rod around which the solid electrolyte-containing sheet was wound without abnormality<14 mm

3: 14 mm≤the minimum diameter of the rod around which the solid electrolyte-containing sheet was wound without abnormality<20 mm

2: 20 mm≤the minimum diameter of the rod around which the solid electrolyte-containing sheet was wound without abnormality<32 mm

1: 32 mm≤the minimum diameter of the rod around which the solid electrolyte-containing sheet was wound without abnormality

<Evaluation 3: Evaluation of Void Volume>

The obtained solid electrolyte-containing sheet was cut with a razor, and a cross-section of the solid electrolyte-containing sheet was exposed by ion milling (manufactured by Hitachi High-Technologies Corporation, IM4000PLUS (trade name)). The cross-section was observed with a tabletop microscope (manufactured by Hitachi High-Technologies Corporation: Miniscope TM3030PLUS (trade name)), and the obtained image was processed to calculate a void volume (the total area of void portions/the total area of the measurement region). The void volume was evaluated based on the following evaluation standards.

In this test, as the void volume decreases, the solid particles are more densely deposited in the solid electrolyte layer, which shows that a function of improving the ion conductivity and the energy density is exhibited. An evaluation rank of “4” or higher is an acceptable level.

—Evaluation Standards—

8: 0<Void volume≤0.01

7: 0.01<Void volume≤0.02

6: 0.02<Void volume≤0.04

5: 0.04<Void volume≤0.06

4: 0.06<Void volume≤0.08

3: 0.08<Void volume≤0.10

2: 0.10<Void volume≤0.15

1: 0.15<Void volume

<Evaluation 4: Measurement of Ion Conductivity>

The solid electrolyte-containing sheet obtained as described above was cut in a disk shape having a diameter of 14.5 mm, and this solid electrolyte-containing sheet was put into a coin case 11 shown in FIG. 2. Specifically, an aluminum foil (not shown in FIG. 2) cut in a disk shape having a diameter of 15 mm was brought into contact with the solid electrolyte layer of the solid electrolyte-containing sheet to form a laminate 12 for an all-solid state secondary battery (a laminate consisting of aluminum-solid electrolyte layer-aluminum), and the laminate 12 was put into a 2032-type coin case 11 formed of stainless steel equipped with a spacer and a washer (both of which are not shown in FIG. 2). By swaging the coin case 11, an all-solid state secondary battery 13 as a tool for ion conductivity measurement was prepared.

Using the obtained tool for ion conductivity measurement obtained as described above, the ion conductivity was measured. Specifically, the alternating current impedance was measured at a voltage magnitude of 5 mV in a frequency range of 1 MHz to 1 Hz using a 1255B frequency response analyzer (trade name, manufactured by SOLARTRON) in a constant-temperature tank at 30° C. As a result, the resistance of the sample in a thickness direction was obtained by calculation from the Expression (1).

Ion Conductivity (mS/cm)=1000×Sample Thickness (cm)/{Resistance (n)×Sample Area (cm²)} Expression (1)

In Expression (1), the sample thickness and the sample area were values obtained by performing the measurement before putting the laminate 12 for an all-solid state secondary battery into the 2032-type coin case 16.

An evaluation rank to which the obtained ion conductivity belongs was determined among the following evaluation ranks.

In this test, an evaluation rank of “4” or higher for the ion conductivity was an acceptable level.

—Evaluation Standards—

8: 0.5 mS/cm≤Ion conductivity

7: 0.4 mS/cm≤Ion conductivity<0.5 mS/cm

6: 0.3 mS/cm≤Ion conductivity<0.4 mS/cm

5: 0.2 mS/cm≤Ion conductivity<0.3 mS/cm

4: 0.1 mS/cm≤Ion conductivity<0.2 mS/cm

3: 0.05 mS/cm≤Ion conductivity<0.1 mS/cm

2: 0.01 mS/cm≤Ion conductivity<0.05 mS/cm

1: Ion conductivity<0.01 mS/cm

TABLE 2

| Solid Electrolyte Composition | | | | | | | | | | | |
|---|---|---|---|---|---|---|---|---|---|---|---|
| | Sulfide-Based Inorganic | | | | | | | | | | |
| | Solid Electrolyte | | Polymer | | | | | Solid Electrolyte-Containing Sheet | | | |
| | | Content | | Content | Dispersion | CLogP | | | Binding | | Ion |
| No. | Kind | (mass %) | Kind | (mass %) | Medium | Value | Dispersibility | No. | Properties | Void | Conductivity |
| C-1 | LPS | 97% | B-1 | 3% | THF | 0.5 | 5 | S-1 | 5 | 4 | 4 |
| C-2 | LPS | 97% | B-1 | 3% | Butyl Butyrate | 2.8 | 6 | S-2 | 6 | 5 | 6 |
| C-3 | LPS | 97% | B-2 | 3% | Butyl Butyrate | 2.8 | 6 | S-3 | 5 | 5 | 6 |
| C-4 | LPS | 97% | B-3 | 3% | Butyl Butyrate | 2.8 | 6 | S-4 | 6 | 6 | 6 |
| C-5 | LPS | 97% | B-4 | 3% | Butyl Butyrate | 2.8 | 6 | 5-5 | 6 | 7 | 6 |
| C-6 | LPS | 97% | B-5 | 3% | Butyl Butyrate | 2.8 | 6 | S-6 | 7 | 7 | 6 |
| C-7 | LPS | 97% | B-6 | 3% | Butyl Butyrate | 2.8 | 5 | S-7 | 5 | 5 | 5 |
| C-8 | LPS | 97% | B-7 | 3% | Butyl Butyrate | 2.8 | 7 | S-8 | 8 | 7 | 6 |
| C-9 | LPS | 97% | B-8 | 3% | Butyl Butyrate | 2.8 | 8 | S-9 | 7 | 7 | 6 |
| C-10 | LPS | 97% | B-9 | 3% | Butyl Butyrate | 2.8 | 8 | S-10 | 7 | 7 | 7 |
| C-11 | LPS | 97% | B-10 | 3% | Butyl Butyrate | 2.8 | 8 | S-11 | 7 | 8 | 8 |
| C-12 | LPS | 97% | B-11 | 3% | Butyl Butyrate | 2.8 | 8 | S-12 | 8 | 8 | 8 |
| BC-1 | LPS | 97% | BC-1 | 3% | Butyl Butyrate | 2.8 | 3 | BS-1 | 3 | 2 | 2 |
| BC-2 | LPS | 97% | BC-2 | 3% | Butyl Butyrate | 2.8 | 2 | BS-2 | 1 | 2 | 2 |

<Notes in Table>
LPS: the sulfide-based inorganic solid electrolyte (Li—P—S-based glass)
THF: tetrahydrofuran

As can be seen from Table 2, in the solid electrolyte compositions BC-1 and BC-2 including the polymer not having the structural unit represented by Formula (H-1) or (H-2), the dispersibility was poor. In the solid electrolyte-containing sheets BS-1 and BS-2 prepared using the solid electrolyte compositions BC-1 and BC-2, the evaluation of the binding properties and the evaluation of the void volume were unacceptable, and the ion conductivity was also unacceptable.

In the solid electrolyte compositions C-1 to C-12 and the solid electrolyte-containing sheets S-1 to 5-12 including the polymer having the structural unit represented by Formula (H-1) or (H-2), the results of all the evaluation items were excellent.

In addition, it can be seen from the results of the solid electrolyte compositions C-2, C-5, and C-6 that, in a case where the content of the specific structural unit defined by the present invention is 2 mass % or higher with respect to the mass of the polymer, the dispersibility is further improved. In addition, it can be seen from the results of the solid electrolyte-containing sheets S-2, S-5, and S-6 that, in a case where the content of the specific structural unit defined by the present invention is 2 mass % or higher with respect to the mass of the polymer, the void volume can be further reduced.

### Example 2

An all-solid state secondary battery was manufactured, and the following properties thereof were evaluated. The results are shown in Table 3.

<Preparation of Positive Electrode Composition>

180 zirconia beads having a diameter of 5 mm were put into a 45 mL zirconia container (manufactured by Fritsch Japan Co., Ltd.), and 2.7 g of LPS synthesized as described above, the dispersion liquid (0.3 g in terms of solid contents) of the dispersion liquid or solution of the polymer shown in Table 3, and 22 g of the dispersion medium shown in Table 3 were put thereinto. The container was set in a planetary ball mill P-7 (trade name, manufactured by Fritsch Japan Co., Ltd.) and the components were stirred for 10 minutes at 25° C. and a rotation speed of 150 rpm. Next, 7.0 g of LiNi_{1/3}Co_{1/3}Mn_{1/3}O₂ (NMC) as a positive electrode active material was put thereinto. Next, using the same method, the container was set in a planetary ball mill P-7 and the components were continuously mixed together for 5 minutes at 25° C. and a rotation speed of 100 rpm. As a result, positive electrode compositions U-1 to U-12, V-1, and V-2 were prepared.

TABLE 3

| | | | | | | | | Positive |
|---|---|---|---|---|---|---|---|---|
| Positive Electrode Composition | | | | | | | | Electrode |
| | Positive | | | | | | | Sheet |
| | Electrode | | | | Polymer | | | for All- |
| | Active | | Inorganic | | | Con- | | Solid |
| | Material | | Solid | | | tent | Dis- | State |
| | | Content | Electrolyte | | | (mass | persion | Secondary |
| No. | Kind | (mass %) | Kind | % | Kind | %) | Medium | Battery |
| U-1 | NMC | 70 | LPS | 27 | B-1 | 3 | THF | PU-1 |
| | | | | | | | Butyl | |
| U-2 | NMC | 70 | LPS | 27 | B-1 | 3 | Butyrate | PU-2 |
| | | | | | | | Butyl | |
| U-3 | NMC | 70 | LPS | 27 | B-2 | 3 | Butyrate | PU-3 |
| U-4 | NMC | 70 | LPS | 27 | B-3 | 3 | Butyl | PU-4 |
| | | | | | | | Butyrate | |
| | | | | | | | Butyl | |
| U-5 | NMC | 70 | LPS | 27 | B-4 | 3 | Butyrate | PU-5 |
| U-6 | NMC | 70 | LPS | 27 | B-5 | 3 | Butyl | PU-6 |
| | | | | | | | Butyrate | |
| | | | | | | | Butyl | |
| U-7 | NMC | 70 | LPS | 27 | B-6 | 3 | Butyrate | PU-7 |
| U-8 | NMC | 70 | LPS | 27 | B-7 | 3 | Butyl | PU-8 |
| | | | | | | | Butyrate | |
| U-9 | NMC | 70 | LPS | 27 | B-8 | 3 | Butyl | PU-9 |
| | | | | | | | Butyrate | |
| U-10 | NMC | 70 | LPS | 27 | B-9 | 3 | Butyl | PU-10 |
| | | | | | | | Butyrate | |
| U-11 | NMC | 70 | LPS | 27 | B-10 | 3 | Butyl | PU-11 |
| | | | | | | | Butyrate | |
| | | | | | | | Butyl | |
| U-12 | NMC | 70 | LPS | 27 | B-11 | 3 | Butyrate | PU-12 |
| V-1 | NMC | 70 | LPS | 27 | BC-1 | 3 | Butyl | PV-1 |
| | | | | | | | Butyrate | |
| V-2 | NMC | 70 | LPS | 27 | BC-2 | 3 | Butyl | PV-2 |
| | | | | | | | Butyrate | |

<Abbreviations of Table>
NMC: LiNi_{1/3}Co_{1/3}Mn_{1/3}O₂
LPS: the sulfide-based inorganic solid electrolyte (Li—P—S-based glass)
THF: tetrahydrofuran

<Preparation of Positive Electrode Sheet for All-Solid State Secondary Battery>

The positive electrode composition obtained as described above was applied to an aluminum foil (positive electrode current collector) having a thickness of 20 μm using a Baker Type applicator (trade name: SA-201, manufactured by Tester Sangyo Co., Ltd.), and was heated at 80° C. for 2 hours to dry the positive electrode composition (to remove the dispersion medium). Next, using a heat press machine, the positive electrode composition that was dried was pressurized at 25° C. (10 MPa, 1 minute). As a result, positive electrode sheet PU-1 to PU-12, PV-1, and PV-2 for an all-solid state secondary battery including the positive electrode active material layer having a thickness of 80 μm were prepared.

Next, the solid electrolyte-containing sheet shown in Table 4 and prepared in Example 1 was disposed on the obtained positive electrode active material layer of each of the positive electrode sheets for an all-solid state secondary battery shown in Table 4 such that the solid electrolyte layer was in contact with the positive electrode active material layer, was pressurized at 25° C. at 50 MPa using a press machine to be transferred (laminated), and was pressurized at 25° C. at a pressure of 600 MPa. As a result, the positive electrode sheet PU-1 to PU-12, PV-1, and PV-2 for an all-solid state secondary battery including the solid electrolyte layer having a thickness of 50 μm were prepared.

<Manufacturing of All-solid State Secondary Battery>

Each of the positive electrode sheets for an all-solid state secondary battery (the aluminum foil of the solid electrolyte-containing sheet was peeled off) was cut out in a disk shape having a diameter of 14.5 mm, as shown in FIG. 2, the cut sheet was put into a 2032-type coin case 11 formed of stainless steel equipped with a spacer and a washer (not shown in FIG. 2), and a graphite negative electrode layer (negative electrode active material layer) having a sheet shape was laminated on the solid electrolyte layer. Further, a stainless steel foil (negative electrode current collector) was further laminated on the negative electrode layer. As a result, a laminate 12 for an all-solid state secondary battery (a laminate including aluminum, the positive electrode active material layer, the solid electrolyte layer, the graphite negative electrode layer, and stainless steel) was formed. Next, by swaging the 2032-type coin case 11, all-solid state secondary batteries 201 to 212, c21, and c22 shown in FIG. 2 were manufactured. The all-solid state secondary battery 13 manufactured as described above has the layer configuration shown in FIG. 1.

<Evaluation 1: Discharge Capacity Retention Ratio (Cycle Characteristics)>

Regarding the all-solid state secondary batteries 201 to 212, c21, and c22, the discharge capacity retention ratio was measured, and cycle characteristics were evaluated.

The discharge capacity retention ratio of each of the all-solid state secondary batteries was measured using a charging and discharging evaluation device “TOSCAT-3000” (trade name, manufactured by Toyo System Corporation). Charging was performed at a current density of 0.1 mA/cm² until the battery voltage reached 3.6 V. Discharging was performed at a current density of 0.1 mA/cm² until the battery voltage reached 2.5 V. One charging operation and the discharging operation was set as one cycle, and three cycles of charging and discharging were repeated. Next, the all-solid state secondary battery was initialized. When the discharge capacity (initial discharge capacity) of one cycle of charging and discharging after the initialization was represented by 100%, the number of charging and discharging cycles in which the discharge capacity retention ratio (discharge capacity relative to the initial discharge capacity) reached 80% was counted, and cycle characteristics were evaluated based one of the following evaluation ranks where the number of charging and discharging cycles was included.

In this test, regarding the discharge capacity retention ratio, an evaluation rank of “5” or higher was an acceptable level.

The initial discharge capacities of all the all-solid state secondary batteries 201 to 212 were sufficient for functioning as the all-solid state secondary batteries.

—Evaluation Rank of Discharge Capacity Retention Ratio—

8: 500 cycles or more

7: 300 cycles or more and less than 500 cycles

6: 200 cycles or more and less than 300 cycles

5: 150 cycles or more and less than 200 cycles

4: 80 cycles or more and less than 150 cycles

3: 40 cycles or more and less than 80 cycles

2: 20 cycles or more and less than 40 cycles

1: less than 20 cycles

<Evaluation 2: Resistance>

Regarding the all-solid state secondary batteries 201 to 212, c21, and c22, the resistance was measured, and the magnitude of resistance was evaluated.

The resistance of each of the all-solid state secondary batteries was evaluated using a charging and discharging evaluation device “TOSCAT-3000” (trade name, manufactured by Toyo System Corporation). Charging was performed at a current density of 0.1 mA/cm² until the battery voltage reached 4.2 V. Discharging was performed at a current density of 0.2 mA/cm² until the battery voltage reached 2.5 V. One charging operation and the discharging operation was set as one cycle, and three cycles of charging and discharging were repeated. After performing discharging at 5 mAh/g (amount of electricity per 1 g of the mass of the active material) of the third cycle, the battery voltage was read. The resistance of the all-solid state secondary battery was evaluated based on one of the following evaluation ranks in which this battery voltage was included. As the battery voltage increases, the resistance decreases. In this test, an evaluation rank of “4” or higher was an acceptable level.

—Evaluation Rank of Resistance—

8: 4.1 V or higher

7: 4.0 V or higher and lower than 4.1 V

6: 3.9 V or higher and lower than 4.0 V

5: 3.7 V or higher and lower than 3.9 V

4: 3.5 V or higher and lower than 3.7 V

3: 3.2 V or higher and lower than 3.5 V

2: 2.5 V or higher and lower than 3.2 V

1: charging and discharging was not able to be performed

TABLE 4

| | Layer | | | | |
|---|---|---|---|---|---|
| | Configuration | | | | |
| | Positive | Solid | Discharge | | |
| | Electrode | Electrolyte | Capacity | Resist- | |
| No. | Layer | Layer | Retention | ance | Note |
| 201 | PU-1 | S-1 | 5 | 4 | Present |
| | | | | | Invention |
| 202 | PU-2 | S-2 | 6 | 6 | Present |
| | | | | | Invention |
| 203 | PU-3 | S-3 | 5 | 6 | Present |
| | | | | | Invention |
| 204 | PU-4 | S-4 | 6 | 6 | Present |
| | | | | | Invention |
| 205 | PU-S | 5-5 | 6 | 6 | Present |
| | | | | | Invention |
| 206 | PU-6 | S-6 | 6 | 7 | Present |
| | | | | | Invention |
| 207 | PU-7 | S-7 | 5 | 5 | Present |
| | | | | | Invention |
| 208 | PU-8 | S-8 | 7 | 7 | Present |
| | | | | | Invention |
| 209 | PU-9 | S-9 | 7 | 7 | Present |
| | | | | | Invention |
| 210 | PU-10 | S-10 | 7 | 7 | Present |
| | | | | | Invention |
| 211 | PU-11 | S-11 | 7 | 8 | Present |
| | | | | | Invention |
| 212 | PU-12 | S-12 | 8 | 8 | Present |
| | | | | | Invention |
| C21 | PV-1 | BS-1 | 3 | 2 | Comparative |
| | | | | | Example |
| C22 | PV-2 | BS-2 | 1 | 2 | Comparative |
| | | | | | Example |

As can be seen from Table 4, in the all-solid state secondary batteries c21 and c22 including the binder that did not include the polymer, the discharge capacity retention ratio and the resistance were poor, the polymer including the structural unit having 6 or more carbon atoms represented by Formula (H-1) or (H-2).

On the other hand, in the all-solid state secondary batteries 201 to 212 including the binder that included the polymer, the discharge capacity retention ratio and the resistance were excellent, the polymer including the structural unit having 6 or more carbon atoms represented by Formula (H-1) or (H-2).

In addition, a solid electrolyte composition was prepared using the same method as that of the solid electrolyte compositions C-1 to C-12, except that an oxide-based inorganic solid electrolyte Li_{0.33}La_{0.55}TiO₃ (LLT) was used instead of LPS. Using this solid electrolyte composition, a solid electrolyte-containing sheet was prepared using the same method as described above. In a case where the above-described properties of the solid electrolyte composition and the solid electrolyte-containing sheet were evaluated, excellent results were obtained. In addition, a positive electrode composition was prepared using the same method as that of the positive electrode compositions U-1 to U-12, except that an oxide-based inorganic solid electrolyte Li_{0.33}La_{0.55}TiO₃ (LLT) was used instead of LPS. Using this positive electrode composition, an all-solid state secondary battery was prepared using the above-described method. In a case where the above-described properties of the all-solid state secondary battery were evaluated, excellent results were obtained.

The present invention has been described using the embodiments. However, unless specified otherwise, any of the details of the above description is not intended to limit the present invention and can be construed in a broad sense within a range not departing from the concept and scope of the present invention disclosed in the accompanying claims.

The present application claims priority based on JP2018-141431 filed on Jul. 27, 2018, the entire content of which is incorporated herein by reference.

### Explanation of References

1: negative electrode current collector
2: negative electrode active material layer
3: solid electrolyte layer
4: positive electrode active material layer
5: positive electrode current collector
6: operation portion
10: all-solid state secondary battery
11: 2032-type coin case
12: laminate for all-solid state secondary battery
13: all-solid state secondary battery

What is claimed is:

1. A solid electrolyte composition comprising:
(A) an inorganic solid electrolyte having ion conductivity of a metal belonging to Group 1 or Group 2 in the periodic table;
(B) a binder including a polymer that includes a structural unit having 6 or more carbon atoms represented by Formula (H-3) or (H-4); and
(C) a dispersion medium, 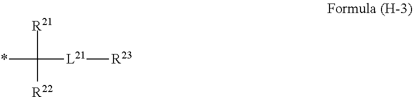
in the formula, R²¹ represents a methyl group, a cyano group, an alkyloxycarbonyl group, an alkylcarbonyloxy group, or a 2-imidazolin-1-yl group,
R²² represents an alkyl group having 1 to 6 carbon atoms, a cyano group, an alkyloxycarbonyl group, or an alkylcarbonyloxy group,
R²³ represents a cycloalkyl group, a methoxy group, a hydroxy group, a carboxy group, a 2-imidazolin-1-yl group, or an aryl group,
in a case where R²³ represents a cycloalkyl group, R²³ may linked to R²¹,
L²¹ represents a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups,
R^{N} represents a hydrogen atom or an alkyl group having 1 to 12 carbon atoms,
“L²¹-R²³” does not represent “an alkylene group having 1 to 6 carbon atoms—an aryl group”, and
* represents a binding site to a polymer main body, 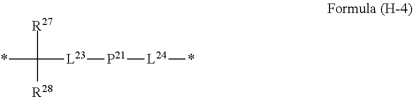
in the formula, R²⁷ and R²⁸ each independently represent a cyano group, an alkyl group having 1 to 6 carbon atoms, an alkyloxycarbonyl group, or an alkylcarbonyloxy group,
L²³ and L²⁴ each independently represent a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups,
R^{N} represents a hydrogen atom or an alkyl group having 1 to 12 carbon atoms,
P² represents a polyalkyleneoxy group or a polyalkoxysilylene group, and
* represents a binding site to a polymer main body.

2. The solid electrolyte composition according to claim 1,
wherein the polymer in the binder is formed of particles having an average particle size of 5 nm to 10 μm.

3. The solid electrolyte composition according to claim 1,
wherein the structural unit represented by Formula (H-4) is a structural unit represented by Formula (H-5), 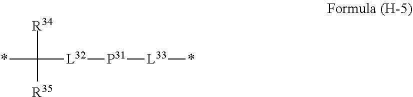
in the formula, R³⁴ and R³⁵ each independently represent a cyano group, an alkyl group having 1 to 6 carbon atoms, an alkyloxycarbonyl group, or an alkylcarbonyloxy group,
L³² and L³³ each independently represent a single bond, an alkylene group having 1 to 6 carbon atoms, an oxygen atom, —N(R^{N})—, a carbonyl group, a silane linking group, an imine linking group, or a group including a combination of two or more among the above-described groups, atoms, and linking groups,
P³¹ represents a polyalkyleneoxy group or a polyalkoxysilane group having a mass average molecular weight of 1000 or higher,
R^{N} represents a hydrogen atom or an alkyl group having 1 to 12 carbon atoms, and
* represents a binding site to a polymer main body.

4. The solid electrolyte composition according to claim 1,
wherein the polymer in the binder (B) does not include a component having 2 or more polymerizable sites.

5. The solid electrolyte composition according to claim 1,
wherein the polymer in the binder (B) includes a repeating unit (K) represented by Formula (R-1), 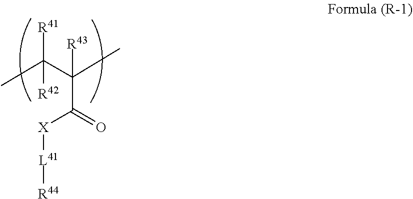
in the formula, R⁴¹ to R⁴³ each independently represent a hydrogen atom, a cyano group, a halogen atom, or an alkyl group,
X represents an oxygen atom or NR^{N},
R^{N} represents a hydrogen atom or an alkyl group having 1 to 12 carbon atoms,
L⁴¹ represents a linking group, and
R⁴⁴ represents a substituent.

6. The solid electrolyte composition according to claim 1,
wherein a content of the structural unit having 6 or more carbon atoms represented by Formula (H-3) or (H-4) is 2 mass % or higher with respect to a mass of the polymer in the binder (B).

7. The solid electrolyte composition according to claim 1,
wherein the polymer in the binder (B) includes at least one selected from Group (a) of functional groups,
Group (a) of functional groups
a carboxy group, a sulfonate group, a phosphate group, a phosphonate group, an isocyanate group, and a silyl group.

8. The solid electrolyte composition according to claim 5,
wherein the repeating unit (K) includes at least one selected from Group (a) of functional groups, and
a content of the repeating unit (K) is 15 mass % or higher with respect to all components of the polymer in the binder (B),
Group (a) of functional groups
a carboxy group, a sulfonate group, a phosphate group, a phosphonate group, an isocyanate group, and a silyl group.

9. The solid electrolyte composition according to claim 1,
wherein the inorganic solid electrolyte (A) is a sulfide-based inorganic solid electrolyte.

10. The solid electrolyte composition according to claim 1,
wherein the dispersion medium (C) includes at least one selected from a ketone compound solvent, an ester compound solvent, an aromatic compound solvent, or an aliphatic compound solvent.

11. The solid electrolyte composition according to claim 1, comprising:
(D) an active material capable of intercalating and deintercalating ions of a metal belonging to Group 1 or Group 2 in the periodic table.

12. A solid electrolyte-containing sheet comprising:
a layer formed of the solid electrolyte composition according to claim 1.

13. An all-solid state secondary battery comprising a positive electrode active material layer, a solid electrolyte layer, and a negative electrode active material layer in this order,
wherein at least one of the positive electrode active material layer, the solid electrolyte layer, or the negative electrode active material layer is formed of the solid electrolyte composition according to claim 1.

14. A method of manufacturing a solid electrolyte-containing sheet, the method comprising:
forming a film using the solid electrolyte composition according to claim 1.

15. A method of manufacturing an all-solid state secondary battery, the method comprising:
manufacturing an all-solid state secondary battery using the method according to claim 14.
